(19) United States
(12) Patent Application Publication
(10) Pub. No.: US 2018/0266169 A1
(43) Pub. Date: Sep. 20, 2018

(54) GARAGE DOOR SYSTEMS AND METHODS

(71) Applicant: BioFilm IP, LLC, Minden, NV (US)

(72) Inventors: Daniel X. Wray, Genoa, NV (US); Ericson C. Ceniceros, Reno, NV (US); Reed Nicholas Liu, Reno, NV (US); Anthony Zunino, Reno, NV (US); Olivia Tanguileg, Reno, NV (US); Benjamin Wallace, Henderson, NV (US); Khalid M. Rumjahn, JR., Reno, NV (US); Hunter A. Tyzbir, Reno, NV (US)

(21) Appl. No.: 15/921,105

(22) Filed: Mar. 14, 2018

Related U.S. Application Data
(60) Provisional application No. 62/471,330, filed on Mar. 14, 2017.

(51) Int. Cl. E06B 3/48; E06B 3/70; E06B 7/20; E06B 3/30; E05D 15/06; E05F 15/40; E05F 15/70; E05F 15/643

(52) U.S. Cl. CPC E06B 3/485; G08B 17/10; E06B 7/20; E06B 3/30; E05D 15/0656; E05D 15/0652; E05F 15/40; E05F 15/70; E05F 15/643; E06B 2003/7023; E06B 2003/7044; E06B 2003/703; E05Y 2201/434; E05Y 2201/656; E05Y 2400/32; E05Y 2400/44; E05Y 2400/85; E05Y 2900/106; E06B 3/7015

(57) ABSTRACT

Provided are door systems having a plurality of door panels and a frame, the door panels being movable horizontally between an extended position closing an opening in a building structure, and a folded retracted position opening the opening in the building structure. When in the extended position, the door panels interlock with each other forming a barrier to wind, dirt, dust and insects. The frame is movably attached to the building structure and when the door panels are in the extended position, the frame moves and engages the door panels with a sealing member to provide an airtight seal of the opening in the building structure.

### RELATED APPLICATIONS

Benefit of priority is claimed to U.S. Provisional Application No. 62/471,330, titled “GARAGE DOOR SYSTEMS AND METHODS,” filed Mar. 14, 2017, the subject matter of which is incorporated by reference herein in its entirety.

This application is related to International PCT Application No. (Attorney Docket No. 33348-9818PC), filed the same day herewith, entitled “GARAGE DOOR SYSTEMS AND METHODS,” which also claims priority to U.S. Provisional Application Ser. No. 62/471,330. The subject matter of the above-noted International application is incorporated by reference herein in its entirety.

### FIELD

The present invention relates generally to a door system having a plurality of door panels and a frame, the door panels being movable between an extended position closing an opening in a building structure, and a folded retracted position, opening the opening in the building structure. When in the extended position, the door panels interlock with each other forming a barrier to wind, dirt, dust and insects. The frame is movably attached to the building structure and, when the door panels are in the extended position, the frame moves until the panels engage with a sealing member to provide an airtight seal.

### BACKGROUND

Typical garage doors can include several sections interconnected by hinges that can be moved on a pair of rails or tracks and can be moved from a closed vertical position to an open horizontal position. The panels typically includes rollers at their edge, the rollers connected to the rails or in the tracks and allowing movement of the sections. The door is of a size so that it covers the entire opening of the building structure, e.g., garage. Because most garage doors include four sections, each section of an seven-foot having four sections would have a height of about 21, and each section of a typical eight-foot four-section door would have a height of about 24 inches. Because the door when in the open horizontal position has the same size as when it is in the closed vertical position, it occupies a large area of the ceiling that otherwise could be put to other uses, such as storage. Rolling garage doors that can be rolled up into a cylinder are known, but such doors offers little insulation properties, have very little esthetic properties and fail to seal out wind, dirt and insects.

Sectional overhead garage doors are known (e.g., see U.S. Pat. No. 3,618,656 (Young, 1971); U.S. Pat. No. 4,460,030 (Tsunemura et al., 1984); and U.S. Pat. No. 8,371,356 (Manser, 2013); and U.S. Pat. App. Pub. Nos. US2005/U.S. Pat. No. 0,072,537 (Pfender, 2005) and US2010/U.S. Pat. No. 0,287,840 (Godovalov, 2010)). Sectional overhead doors can include a plurality of horizontally oriented door sections pivotally connected together via hinges to form an articulated door. The door sections typically include sets of rollers at their ends that are supported between fixed rails or tracks that guide the movement of the door between a vertically oriented closed position to an overhead, substantially horizontal open position. The sections pivot relative to each other as the sections travel between the open and closed positions. Automatic garage door openers can be used to move the doors between the open and closed positions.

Sectional garage doors that open horizontally also are known (e.g., see U.S. Pat. No. 5,267,597 (Green, 1993); U.S. Pat. No. 5,425,409 (Guia, 1995); and U.S. Pat. No. 8,156,992 (Diaz et al., 2012)). Such doors can include a plurality of vertically oriented door sections pivotally connected together via hinges to form an articulated door. The door sections typically include sets of rollers that are supported between fixed rails or tracks that guide the movement of the door between a closed position and an open position.

The design of the electric garage door has been relatively unchanged for several decades. Consumers have often desired an aesthetic look, but most conventional garage doors are nondescript. Many are made of sheets of thin inexpensive metal which are typically filled with an insulation material that results in a thick and bulky door. The metal material can be easily dented and damaged. Because of the weight of the door panels, bulky infrastructure can severely limit storage room within the garage. Mechanical components including springs, bearings, and motors generate the door's movement, which typically creates a loud unappealing noise. The common failure of springs often reduces the system's desired life time to approximately 10-15 thousand opening and closing cycles.

The primary function of a garage door is to protect the inside environment from outdoor conditions. Conventional panels do not completely seal, thus allowing in dust, insects, and more importantly, air that interferes with thermal control and efficiency. Automatic residential garage doors are typically made from aluminum sheets with a polyurethane filler. The metal sheets are thermally conductive and inefficient insulators. To compensate for this inefficiency, around 2″ of thermal insulation are included in the door panels. Even with this thick layer of thermal insulation, heat loss can be significant. This energy loss has been directly translated into increases in increased utility costs. Further, typical garage doors fail to keep out wind, dust and insects.

Not only can conventional garage doors be inefficient, they can be expensive to install. According to On Track Garage Door Service, Inc. a typical garage door installation can cost between $325 and $2,000 dollars, averaging around $1060. Conventional methods of installation are labor, time, and cost intensive. It is clear that there is a significant need for a more efficient and effective garage door systems for keeping out the elements, as well as dirt, dust, insects and pests, that can minimize the garage space occupied by the door and its related mechanical hardware when it is in an open position.

### SUMMARY

The present invention solves these and other problems which exist with conventional garage door systems. Provided are garage door systems and methods that can provide a more consumer-friendly, efficient and effective system and method for opening and closing a building space to the environment, providing a door and door system that are aesthetically pleasing, quiet, clean, and efficient. The systems and methods provided herein provide a collapsible door that can placed in an opening in a building or structure to prevent movement of air, dirt, dust, insects or pests into the building or structure.

It is an object of this invention to provide a door system that substantially reduces the entry of dirt, dust, insects and/or pests into a structure when the door is in the closed position, as well as minimizing the space occupied by the door when it is in the open position. The system can be used for such installations as sectional garage doors and as a closure for building exteriors. The system can include interchangeable and easily replaceable panels that interlock to prevent movement of air, dirt, dust, insects or pests through the system when in the closed position.

Provided are sectional door systems for closing an opening in a building or structure. The systems include a plurality of panels, each panel containing a first face surface; a second face surface; a core; a first edge containing a recessed groove and an opposite second edge containing a tongue portion; or a first edge containing a positive of a half-lap joint, and an opposite second edge containing a negative of a half-lap joint; a frame; an operating mechanism for opening and closing the door horizontally; a sealing member; and a movable connector for movably connecting the frame to the building or structure. The movable connector repositions the frame of the door so that panels of the door engage with a sealing element attached around the opening of the building. The engaging of the panels of the door with the sealing element forms an airtight seal. When a panel includes a recessed groove and a tongue portion, the tongue portion of one panel can be insertable in the recessed area of an adjacent panel to join the panels and inhibit the passage of air therebetween. When a panel includes a positive half-lap joint and a negative half-lap joint, the positive half-lap joint of one panel fits into the cutaway negative half-lap joint of the adjoining panel, thereby joining the first panel to the second panel and inhibiting the passage of air therebetween.

In the door systems provided herein, the core of the panels of the can include a unitary expanded polymeric material. The expanded polymeric material can include a polystyrene foam or polyurethane foam or combinations thereof. The core can have a honeycomb design. The core can include an aerogel, such as a silica aerogel reinforced with glass fiber. The core can include a plurality of insulation microspheres. The core can include one or more vacuum insulated panels.

In the door systems provided herein, the panels can include an insulating material to reduce the transmission of thermal energy or sound energy or both. Each panel can be of a layered composite construction, with different materials layered during fabrication of the panel. The panels can be manufactured using any process. The panels can be fabricated so that they have no visible seams. The panels can have a thermal resistance or R value ranging from 30 to 60.

The panels can be made of a strong, lightweight material. The first face surface or second face surface or both face surfaces of the panels can include a thermoplastic resin, or resin reinforced fiberglass, or carbon-fiber-reinforced plastic, or a composite or a combination thereof. Either or both face surfaces of the panels can include an epoxide resin-based carbon fiber-reinforced plastic. Either or both face surfaces of the panels can include an acrylonitrile butadiene styrene copolymer (ABS), polycarbonate acrylonitrile butadiene styrene copolymer (PC/ABS), polyether-ether-ketone (PEEK), polyetherketone ketone (PEKK), polyethylenimine (PEI), polypropylene (PP), polyphenylene sulfide (PPS), polyvinyl chloride (PVC), or a thermoplastic olefin (TPO) or any combination thereof.

In the door systems provided herein, the panels can include a surface coating. The surface coating can contain a thermoplastic elastomer, a thermoplastic vulcanizate or an aromatic polyurea/polyurethane hybrid elastomer system or combinations thereof. The surface coating can include a Line-X® brand aromatic polyurea/polyurethane hybrid protective coating. The surface coating can be present on an internal surface of the panel, or on an external surface of the panel, such as the first face surface, or the second face surface or any combination thereof. Every surface of the panel can include a surface coating. The panels can be configured so that the first face surface of the panel faces external to the opening of the building or structure, and the second face surface of the panel faces internal to the opening of the building or structure. The panels can be configured so that the core is between the first face surface and second face surface of the panels and adhesively bonded thereto to foam a unitary unit.

In the door systems provided herein, one or more of the panels can include a window. The window can be of any transparent material, such as glass, acrylic and polycarbonate. The transparent material can be present in a single layer, or a plurality of layers. In some configurations, at least two layers of transparent material are present, separated by a space. The space between the two layers of transparent material can be evacuated, or can be filled with an inert gas. The window can include a polymer film. Exemplary polymer films include a polyvinylbutyral (PVB) film and an ethylene vinyl acetate (EVA) film or a combination thereof. The window can include a privacy glass. The window can include an electro-chromic element. The window can include one or more transparent metal oxide layers that can reflect at least one wavelength of electromagnetic radiation. Different transparent metal oxide layers that reflect different wavelengths of electromagnetic radiation can be used in combination.

In the door systems provided herein, one or more of the panels can include a decorative design or embossment. The decorative design or embossment can be on a face surface positioned toward the exterior environment or toward the interior of the building or both. The panel can have one decorative design or embossment on one face surface and a different decorative design or embossment on the other face surface. In the door systems provided herein, one or more of the panels can include an interchangeable cover that can be fastened to the first face surface or the second face surface or both to change the aesthetic appearance of the door. The panels can have a thickness of from about 0.5 to about 3 inches.

In the door systems provided herein, a coupling joining adjacent panels can be included. The coupling can include a hinge. The hinge can be located anywhere between the panels that allow the panels to pivot or rotate, such as a side or top edge.

In the door systems provided herein, a surface of the recessed groove or a surface of the negative of the half-lap joint of a panel can include a compressible elastomeric material. The compressible elastomeric material include a rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof. The recessed groove can be configured to have any appropriate shape. The recessed groove can have a shape selected from among rectangular, tapered and U-shaped.

In the door systems provided herein, the frame can include an upper track and a lower track. The upper track and the lower track can include a groove that can engage with a wheel that allows the panels to move along the track. The wheel can be of any material, such as metal, nylon, plastic or wood, or combinations thereof. In some embodiments, the lower track can be or include a sturdy elastomeric polymer, such as rubber, vulcanized rubber, neoprene, polychloroprene rubber, a copolymer of butadiene and styrene, such as BUNA-S or BUNA-N, thiokol or any combination thereof. The wheel can include a coating selected from among an elastomeric coating, a polymer coating, a Teflon coating, a plastic coating and a nylon coating. The lower track can be movably attached to a rail affixed to a floor of a building. A sealing element can be located between the movable rail and the floor and can form an airtight seal therebetween. The upper track or the lower track or both can include a surface coating. The surface coating can include an elastomeric coating. Exemplary elastomeric coatings can be or contain a polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or combinations thereof. The sealing member when engaged with the panels of the door can provide a hermetic seal.

The door systems provided herein can include a light activated when the door operating mechanism is energized, or a receiver responsive to a transmitter, or an obstruction sensor or a reverse trip switch or both, or any combination thereof. The obstruction sensor can include an infrared optical sensor. The door systems provided herein can include a manual switch to deactivate the door system, a carbon monoxide sensor and an alarm, a smoke detector and an alarm, an infrared tripping sensor, a variable resistance sensor, a particle detector or air quality sensor, or any combination thereof.

The door systems provided herein can include a computer module. The computer module can include a computer in communication with and/or in control of any part of the door system. The computer can communicate with a control system to automate or operate the opening and closing of the door. The computer can communicate with a control system to operate a light, a mechanical component, an operating mechanism, a touch panel, or automatic closing and locking mechanisms or any combination thereof. The computer module can include a non-transitory computer-readable storage medium having a computer-readable program embodied therein for directing operation of the door system and/or any component of the system. The door systems provided herein can be configured to interact with a smart house product, or to interact with a smart phone.

The door systems provided herein provide a sealing member that is affixed to at least the two vertical sides and top horizontal portion of the opening of the building. The sealing member is attached on the inside of the opening so that it is not visible from the outside of the building. The sealing member is attached to the building using any fastener known in the art. Typical fasteners include screws, nails, clips, clamps and adhesives, such as glue or epoxy. The sealing member can include a compressible material that is reversibly deformable and that can conform in shape to the surface of an object brought into contact with the sealing member. The compressible material can include a sponge rubber or a foamed plastic or a plastic resin or a compressible elastomeric material comprising rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or combinations thereof. The sealing member can include a resilient semi-circular strip of elastomeric compressible material. The sealing member can include a hollow opening in the interior of the sealing member that extends the length of the material. The sealing member comprises an elastomeric reservoir containing a quantity of fluid secured to a header above the opening of the building or structure and spaced tubular elastomeric members secured at each side of the door opening to the building structure, where fluid forced into the tubular members extend them into sealing contact with the side edges of the panels of the door.

In the door systems provided herein, the movable connector can include an electro-mechanical connector, an electric-hydraulic connector, a hydraulic connector, a pneumatic connector, an electro-pneumatic connector, a solenoid valve connector, a mechanical spring connector, or a combination thereof. The movable connector can include a threaded member that can move the frame toward the building or structure to engage with the sealing member to form a seal, and move the frame away from the building or structure to disengage with the sealing member. The movable connector can include a pair of metal plates that contain an internally threaded opening that accepts the threaded member. One metal plate of the pair can be attached to an element of the structure, and the other metal plate of the pair can be attached to the frame, and rotation of the threaded member by a motor in one direction repositions the frame toward the opening of the building or structure, and rotation of the threaded member by the motor in the opposite direction repositions the frame away from the opening of the building or structure. The motor can be a direct-current motor driven by a power control signal or a stepper motor. The system can include a control circuit programmed to control rotation of the motor in the forward and reverse directions. The movable connector can include a pair of arms, disposed symmetrically around a central axis, and a piston to push the arms apart or to pull the arms together, thereby bringing the frame toward or away from the building or structure opening. The piston can be operated electrically, hydraulically or pneumatically. The movable connector can include a gear attached to a drive shaft, a motor, and a cable or chain driven by the motor to rotate the gear and drive shaft to reposition the frame of the door closer to or away from the building or structure opening.

In the door systems provided herein, the door operating mechanism can include a mechanical opener, an electromechanical opener, an electrical opener, a hydraulic opener, a pneumatic opener or combinations thereof. The door operating mechanism can include an electric motor, a chain drive mechanism, and a length of a bicycle-type chain geared to the chain drive mechanism driven by the electric motor. The door operating mechanism can include movable trolleys that reposition the panels from an orientation parallel to the opening to an orientation perpendicular to the opening and move the panels to stack the panels abutting each other to form a compact storage of the panels. The door operating mechanism can include an electric motor, a drive mechanism, and a length of toothed belt geared to the drive mechanism driven by the electric motor.

The door systems provided herein can include a mechanical locking system or electronic locking system or a combination thereof. The door systems can include a thermometer or humidity meter. The door systems can include a dehumidifier. The door systems can include an air conditioning system, that can dehumidify the air as well as modify the temperature of the air within the garage or building. The door systems can include a color-coordinated lighting system to convey information. The door systems can include a blower system, which can be configured, for example, to remove debris or water from a car as it enters the garage and passes over the blower system. The door systems can include a ventilation system. The door systems can include an automatic timer. Also provided is a door system that includes a plurality of panels, movable and positionable along guide rails to open and close an opening horizontally, wherein the panels are moved in a direction along the guide rails by a combination of movable trolleys, where the movable trolley runs inside of a guide profile and reposition the panels from an orientation parallel to the opening to an orientation perpendicular to the opening and stack the panels abutting each other to form a compact storage of the panels.

Every component of the system can be built into a pre-made frame and delivered to the customer for installation. The upper and lower tracks are placed along the horizontal axis of the building opening, guiding the panels as they move to open the door, resulting in the panels being stacked against each other, resulting in a compact stack that can be stored in a storage space. The storage space can be built into the frame on either side of the opening or on both sides of the opening. When opened from the middle so that the panels are stored on each side of the opening, two motors can be used to move the panels to each side of the building opening into their respective storage space. When the door panels are extended across the horizontal axis to close the opening, a locking mechanism can be used to secure the doors. Any locking mechanism known in the art can be used (e.g., see U.S. Pat. No. 6,382,005 (White et al., 2002)).

Also provided are methods for sealing an opening of a garage or other structure. The methods include providing a door system provided herein and activating the operating mechanism of the door system to position the panels in their closed position, where the tongue portion of one panel is received into the recessed groove of an adjacent panel, joining the panels and inhibiting the passage of air therebetween; or the extended positive half-lap joint of one panel fits into the cutaway negative half-lap joint of the adjoining panel, thereby joining the first panel to the second panel and inhibiting the passage of air therebetween. The movable connector then is activated to advance the frame towards the opening until the panels are in contact with and form a seal with the sealing member.

Also provided are methods for reversibly converting a garage space into a living space, such as for a man cave, extra bedroom, or home theater. The methods include sealing any vents or drains in the garage and installing the door system provided herein.

Other objects, features and advantages of the systems and methods described herein will become apparent to those skilled in the art from the following detailed description. It is to be understood, however, that the detailed description, while indicating certain embodiments of the systems and methods described herein, are given by way of illustration and not limitation. Many changes and modifications within the scope of the present invention may be made without departing from the spirit thereof.

### DETAILED DESCRIPTION

### BRIEF DESCRIPTION OF THE FIGURES

The drawings described herein are for illustrative purposes only of selected embodiments and not all possible implementations, and are not intended to limit the scope of the present disclosure.

FIG. 1A is a side view of a schematic view of an exemplary door frame system in a position ready for the door to open. FIG. 1B is a side view of a schematic view of an exemplary door frame system in a closed position. FIG. 1C is a side view of the system in a state where the door is in a closed state. FIG. 1D is a side view of the system ready to be opened.

FIG. 2 is a view is from the inside of the garage looking toward the closed door of an exemplary door system.

FIG. 3A is a close up view of the top of a panel showing a spindle attached to the panel with a spindle support within the panel, the spindle also attached to a wheel operably engaged with the upper track of the system. FIG. 3B is a close up view of the bottom of a panel showing a spindle attached to the panel via a spindle support configured to be contained within the panel, and attached to a wheel that can travel in a groove of the lower track.

FIG. 4A is a close up view of the top of a panel showing a spindle attached to the panel with a spindle support on the outside of the panel, the spindle also including a spring assembly and attached to a wheel operably engaged with the upper track of the system.

FIG. 4B shows a close up view of an embodiment of a lower panel with a spring assembly located inside the panel and connected to a spindle, which also is attached to a wheel that is contained in and readily travels within the lower track.

FIG. 5 is an overhead view of the lower track showing a split elastomeric gasket, which can help to keep dirt and debris from entering the lower track.

FIGS. 6A and 6B depict a front view looking toward the garage door from the inside of the building. FIG. 6A shows the door panels when they are closed and FIG. 6B shows the panels moving to each side as the door is opening from the center.

FIG. 6C shows a top view of the door panels as they are opening.

FIGS. 7A through 7E depict alternative embodiments of the door system provided herein. FIG. 7A shows a front view of the door in a closed position when viewed from inside the garage. FIG. 7B shows the same view with the panels rotated 90 degrees so that they are perpendicular to the building opening and parallel to each other. FIG. 7C shows the panels abutting each other in the open position, nested against each other in a stacking region. FIG. 7D illustrates an embodiment where the spindle is located near the center of the door panel. FIG. 7E illustrates and embodiment where the spindle is located at one end of the door panel.

FIG. 8A is a top view of a schematic view of two panels of a door system that contain a first edge containing a tongue portion, and an opposite edge containing a recessed groove, where the tongue portion of one panel is insertable in the recessed area of an adjacent panel to join the panels. In the panels depicted in FIG. 8A, the tongue and groove have the shape of a rectangular open mortise. FIGS. 8B and 8C are top views of a schematic view of a single panel. FIG. 8B shows a panel having a tongue and groove that have a rounded or U-shape bottom. FIG. 8C shows a panel having a tongue and groove that is tapered so that is wider at the top and narrower at the bottom.

FIGS. 9A through 9D are top views of schematic views of two panels of a door system that contain half-lap joints. FIG. 9A illustrates two panels perpendicular to a building opening. FIGS. 9B and 9C illustrate rotation of the panels toward an orientation that this parallel to the door opening. As shown in FIG. 9C, the positive half-lap joint of one panel fits into the cutaway negative half-lap joint of the adjoining panel. FIG. 9D shows the panels with the positive half-lap joint of one panel fits engaged with cutaway negative half-lap joint of the adjoining panel thereby joining the first panel to the second panel, and forming an airtight seal between the two panels.

FIGS. 10A through 10C illustrate one exemplary operating mechanism of the door system. FIG. 10A illustrates trolleys used to reposition the door panels into a stacking position. FIG. 10B illustrates the panel being repositioned at an angle with respect to its starting position and FIG. 10C shows the panel perpendicular to its original position.

FIGS. 11A through 11C illustrate another exemplary operating mechanism of the door system. FIG. 11A illustrates the door panels in a closed position. FIG. 11B shows a motor and mechanism to pivot the panels from a position parallel to the building opening to a position perpendicular to the door opening. FIG. 11C shows the stacked door panels when the door is in an open configuration.

FIG. 12 shows a cutaway top down view, looking down from above the building, of an exemplary configuration of the door system with maximum door opening clearance, having a fixed ceiling rail having a U-shape.

Corresponding figure elements indicate corresponding parts throughout the several views of the drawings. For parts which are similar but not the same as parts originally specified with a given number, a prime (′) of the original number(s) is used. Some components of the system of the present invention include right side components identical to the left side components. In the figures, only one side of the components may be illustrated due to the perspective of the figure, with the understanding that the identical components on the opposite side are present but omitted for clarity of the drawings.

The drawings in the present application and their accompanying detailed description are directed to merely exemplary implementations. The drawings are generally not to scale, some of the dimensions are for the clarity of presentation and are shown exaggerated in the drawings, and are not intended to correspond to actual relative dimensions. Certain elements in some of the figures may be omitted, or illustrated not to scale, for illustrative clarity. The cross-sectional views may be in the form of “slices”, or “near-sighted” cross-sectional views, omitting certain background lines which would otherwise be visible in a “true” cross-sectional view, for illustrative clarity. Further, only those elements which are useful to the understanding of the present invention have been shown and described. Although the views in the drawings for ease of description generally show similar orientations, this depiction in the drawings is arbitrary for the most part and the device could be illustrated and operated in any orientation.

### A. Definitions

Unless defined otherwise, all technical and scientific terms used herein have the same meaning as is commonly understood by one of skill in the art to which the inventions belong.

All patents, patent applications, published applications and publications, websites and other published materials referred to throughout the entire disclosure herein, unless noted otherwise, are incorporated by reference in their entirety.

In the event that there are a plurality of definitions for terms herein, those in this section prevail.

As used here, the singular forms “a,” “an” and “the” include plural referents unless the context clearly dictates otherwise.

As used herein, ranges and amounts can be expressed as “about” a particular value or range. “About” also includes the exact amount. Hence “about 5 percent” means “about 5 percent” and also “5 percent.” “About” means within typical experimental error for the application or purpose intended.

As used herein, “optional” or “optionally” means that the subsequently described element, event or circumstance does or does not occur, and that the description includes instances where the element, event or circumstance occurs and instances where it does not. For example, an optional component in a system means that the component may be present or may not be present in the system.

As used herein, a “collapsible door” refers to a door the panels of which can be folded or stacked into a small space.

As used herein, a “sectional door” refers to a door containing a plurality of panels or sections.

As used herein, a “hermetically sealed” refers to something that excludes the passage of air.

As used herein, “insulation microspheres” refers to hollow bubbles or beads that help to reduce thermal conduction. The microspheres typically are 500 μm, and can be in the size range 0.1 to 500 μm.

As used herein, a “movable connector” is a connector that movably joins one object in relation to another object, and in particular is a connector that can be fixed to a building structure and a door system frame and can move the frame toward and away from the building structure.

### B. Door Systems

Provided herein are garage door systems that will greatly reduce or eliminate the problems common in prior art garage door devices. Provided herein are collapsible door systems for reversibly closing a building opening to the environment. In the door systems provided herein, components of the system are built into a pre-made frame. The frame is movably attached to a support in the building, generally into a support of the building above, left, and right of the opening. The panels of the door are vertically oriented, and open by moving horizontally. The door panels slide along a top and bottom track. In some embodiments, the door can open from one side, such as by the panels moving from left to right or from right to left. In some embodiment, the door can open from the middle or near middle, with the door panels on one side sliding along a top and bottom track to the right of the opening, and the other panels sliding to the left of the opening. The tracks can be placed along the horizontal axis, guiding the panels, and the panels are repositioned so that they face each other. The collapsed panels fit into a storage space within the frame, either on one side of the opening (for side-opening doors) or on each side of the opening (for middle-opening doors). One or more motors operate to effectively move the panels into their respective storage space(s). When closed, the frame is moved against a gasket installed around the building opening, which can act as a locking mechanism to keep the doors securely shut. Individual panels can be equipped with independently rotatable connectors which allows the panel to independently open, such as to allow a person or pet to exit the building without opening the whole door. Sealing mechanisms along the track, frame, and panels can eliminate the influx of air, particles, and other unwanted substances.

The garage door systems provided herein form an airtight seal of an opening of a building or structure, such as a doorway or garage opening, prohibiting wind, dirt, dust pests and insects from entering the structure. The garage door systems provided herein minimize the storage space occupied by the door when in the open position. Although the principles of the present invention are described partly in connection with residential garages and it is particularly advantageous in such usage, it should be understood that this is merely by way of example and that the invention has equal application for any type of overhead doors and can be applied to other types of buildings, such as in sheds, storage facilities, airplane hangars, equipment storage buildings, and warehouses.

### Frame

Unlike conventional garage doors, which move on a frame fixedly attached to the structure, the garage door systems provided herein include a door system frame that is movably attached to the structure, allowing the door to be moved against a sealing member fixed to the structure to form a seal when the door is closed, and allowing the door to be moved away from the sealing member when the door is to be opened. The door system frame is moveably connected to an opening of a structure, such as a doorway in a garage. The opening of the building generally is defined by a horizontal header and a pair of vertical beams located at either end of the opening of the building or structure. The movable connector can be installed so that when the door is to be opened, the connector moves the door away from the opening and slightly upward, such as from 0.2 to 1 inch, so that the bottom of the door moves upward away from the bottom track. A sealing member attached to the bottom of each panel thereby is lifted so that it is not in contact with the track or the floor of the building, eliminating frictional wear that otherwise would be applied to the sealing member as the panels move in the track. This prolongs the life of the sealing member. When the door closes, the movable connector brings the door toward the opening and downward toward the floor, pressing the sealing member of the panels against the lower track or floor or both, creating an airtight seal.

The movable connector can be an electro-mechanical connector, an electric-hydraulic connector, a hydraulic connector, a pneumatic connector, an electro-pneumatic connector, a solenoid valve connector, a mechanical spring connector, or a combination thereof. Exemplary devices that can be used or modified for use are described, e.g., in U.S. Pat. No. 3,554,087 (Florjancic (1971); U.S. Pat. No. 4,523,513 (Gudat et al., 1985); U.S. Pat. No. 5,592,972 (Niethammer (1997); and U.S. Pat. No. 7,059,165 (Siegert et al., 2006). The frame system can be movably connected to the structure using a plurality of connectors.

In some applications, the frame of the garage door system provided herein can be moveably connected to the structure, such as to an element of a building opening, such as a support of a doorway, using an electro-mechanical connector. The electro-mechanical connector can include a motor driven threaded member connected to a corresponding receiving member. In some configurations, the electro-mechanical connector can include a motor driven threaded member attached to the door system frame and a corresponding receiving member attached to an element of the structure, such as an element of the building opening, e.g., a stud or header of a doorway opening. In some configurations, a motor driven threaded member can be attached to an element of the structure, such as an element of the building opening, and a corresponding receiving member can be attached to the door system frame.

The electro-mechanical connector can include a pair of metal plates that contain an internally threaded opening that accepts a threaded member, such as a screw or bolt. The metal plates can be spaced apart but connected via the threaded member. One metal plate of the pair can be attached to an element of the structure, and the other metal plate of the pair can be attached to the door system frame. Rotation of the threaded member by a motor in one direction repositions the door system frame toward the opening of the building or structure, and rotation of the threaded member by the motor in the opposite direction repositions the door system frame away from the opening of the building or structure.

A plurality of metal plates can be fixedly attached about the opening of the building or structure. For example, a metal plate can be located on the interior of the building attached to each vertical beam of a doorway opening. In some configurations, each vertical beam of the doorway opening can include two metal plates spaced apart. In some configurations, each vertical beam of the doorway opening can include a metal plate near the bottom of the doorway opening and a metal plate near the top of the doorway opening. Each metal plate can includes an internally threaded opening that can accept a threaded member, the internally threaded opening of each metal plate corresponding to an internally threaded opening of a corresponding metal plate of a pair. A motor can drive the rotation of the threaded member, the rotation in one direction bringing the metal plates together, and the rotation in the opposite direction moving the plates apart. The motor can be attached to the door system frame, and the motor can drive the rotation of the threaded member that is engaged with an internally threaded opening in a metal plate attached to an element of the building structure, such as an element of the doorway opening.

The motor can be a conventional direct-current (DC) motor driven by a power control signal, or can be a stepper motor that allows a precise amount of rotation of the threaded member by electronically controlling the number of energizing pulses supplied to the motor. The motor can operate to rotate in the forward and reverse directions. A control circuit can be programmed to control rotation of the motor in the forward and reverse directions in response to an indication that the door is to be opened or closed. The motor can include an electronic control unit in communication with the motor that can be programmed to stop rotation of the motor virtually instantaneously once the door system frame has been moved sufficiently toward the opening of the building or structure to engage the panels with the sealing member to seal the opening of the building or structure, such as a doorway.

In some applications, the frame of the garage door system provided herein can be moveably connected to the structure, such as to a structural element of a doorway opening, using a hydraulic or pneumatic connector. The hydraulic or pneumatic connector can include a pair of arms, disposed symmetrically around a central axis, the arms being pivotably mounted at points on the periphery of the apparatus. A hydraulically-operated piston can be used to push the arms apart or to pull the arms together, thereby bringing the door system frame toward or away from the sealing member around the opening of the building or structure. The arms can be connected to a common yoke disposed along the axis of symmetry of the arms, and are pushed apart or pulled together by a piston. The piston can be attached to the yoke and can be hydraulically or pneumatically operated. In some applications, the piston is hydraulically operated, which through the use of appropriate valves, can direct a fluid into a region on either side of the piston, forcing the piston to move in the desired direction. The movement of the piston forces the arms apart or together, according to the direction of the piston. The hydraulic system can include flexible hoses with quick-connect couplings as pressure lines and can include appropriate check valves.

The frame of the garage door system provided herein can be moveably connected to the structure using a chain or cable or belt or a combination thereof. The connector can include a combination of gears and drive shafts, a motor, and a cable or chain or belt driven by the motor to rotate the gears and drive shafts to reposition the frame of the door closer to or away from the doorway opening. The gears can be bicycle-type sprockets mounted on the drive shaft(s) and bicycle-type chains can engage the sprockets. To minimize noise during operation, a belt instead of a metal chain or cable can used.

The upper track of the frame can be configured to ride in or on an upper rail that is fixedly attached to the ceiling of the building. The upper rail allows to upper track to be repositioned closer to or away from the building opening. The upper track can be connected to the upper rail, e.g., by a spring-containing spindle, which allows the upper track to be moved away from the upper rail while still providing support for the upper track.

The frame of the garage door system can include a light activated when the door operating mechanism is energized. The light can have a time delay mechanism that keeps the light in an illuminated state for a predetermined period of time after the door operating mechanism is energized. After the set period, the light is extinguished.

The door frame system can include a receiver responsive to a transmitter. The transmitter can be used to activate the door operating mechanism. The transmitter can be a wireless transmitter, located in the vehicle, or located within the structure, or carried by the operator of the vehicle, or programmed into a smart phone or other computer application software. The transmitter can provide a signal wirelessly to the receiver to open or close the door. The door frame system can include a wall switch connected to the receiver by wiring to actuate the motor. The signal can be an electrical signal transmitted by closure of a push-button switch through electrical wires or by radio frequency from a battery-operated, remote controlled actuating unit. In either case the electrical signals initiate movement of the garage door from the opposite condition in which it resides. If the original state of the garage door is the open position, the actuating signal closes it. Alternatively, when the original state of the garage door is the closed position, the actuating signal will open the garage door. Once movement has been initiated, the system can be deactivated when the garage door movement trips a limit switch as the garage door approaches its open or closed position.

The door frame system can include an upper track and a lower track. The upper track can be movably connected to the building frame, such as to a stud via a movable connector. The upper track can include rails or guide that can interact and support spindles in the panel elements of the door and allow the panel elements to open horizontally instead of vertically. The lower track can be attached to a floor rail that is fixedly mounted to the floor of the building, such as a garage. The floor rail allows the lower track to be positioned away from the door opening when the door is to be opened, and to be positioned toward the door opening when the door is to be closed. Any motorized system can be used to move the lower track in or on the floor rail. For example, a motorized screw can be used, where rotation of the screw in one direction moves the lower track toward the building opening when the door is to be closed, and rotation in the opposite direction moves the lower track away from the door opening when the door is to be opened. A sealing member can be positioned between the floor of the building and the floor rail to provide an airtight seal.

The door frame system can include an obstruction sensor or a reverse trip switch or both. In some configurations, the door frame system can include a pair of photo-eye sensors mounted to project a beam of light of any wavelength across the opening of the building or structure which, when interrupted by an object as the door is closing, will reverse movement of the door to its open position in accord with the Underwriters Laboratories, Inc. (UL) Standards Technical Panel (STP) for ANSI/UL 325, Safety for Door, Drapery, Gate, Louver, and Window Operators and Systems. Preferably, infrared light optical sensors for an auto-reverse safety system are mounted interiorly on both sides of the opening of the building or structure, such as a doorway. The optical sensors can be mounted on the door system frame, or to a portion of the building structure. The infrared optical sensor projects a beam across the opening that detects people, pets or objects that are in the way of the closing door. Any obstruction sensing door reversing device can be included (e.g., see U.S. Pat. No. 4,924,159 (Olson, 1990) and U.S. Pat. App. Pub. No. US2009/0313898 (Manaras, 2009)).

The door frame system can include a manual switch to deactivate the garage door system, which prevents the door frame from moving toward or away from the doorway opening, or the door from opening or closing. The door frame system can include a carbon monoxide sensor and an alarm. The carbon monoxide sensor can be connected to the door operating mechanism. If carbon monoxide levels build within the closed garage area to a dangerous level, an alarm will sound and the carbon monoxide sensor will send a signal that can trigger the door operating mechanism to open the closed garage door (e.g., see U.S. Pat. No. 7,183,933 (Dzurko et al., 2007); U.S. Pat. No. 7,515,058 (Normand, 2009); U.S. Pat. No. 7,710,284 (Dzurko et al., 2010); U.S. Pat. No. 8,669,878 (Vantilburg, 2014); and U.S. Pat. No. 8,803,696 (Dunyan, 2014)). The structure can include other ventilating systems that can remove carbon monoxide, noxious fumes or odors from the closed structure when the door is in the closed position (see U.S. Pat. No. 6,386,969 (O'Brien, 2002); U.S. Pat. No. 9,163,845 (Carlozzi, 2015); and U.S. Pat. App. Pub. No. US2006/U.S. Pat. No. 0,061,313 (Fitzgibbon et al., 2006) and US2009/U.S. Pat. No. 0,124,189 (Barber, 2009)).

Panels

In the garage door systems provided herein, the door system includes a plurality of panels such that, when the door is opened, the panels move sideways and can be stacked in a direction against one another, forming a compact unit for storage. In the broadest context, the garage door system includes components configured and correlated with respect to each other so as to attain the desired objective of forming a seal with the opening of the building (e.g., a garage) and occupying less storage space in the open position than conventional overhead garage doors. The opening is fitting with a sealing member, such as along the top and sides of the opening, the panels include a sealing member on the bottom of each panel, and the frame of the door system is reversibly moved to engage the panels with the sealing member of the opening and to press the sealing member of the panels downward to seal the opening of the building or structure, such as a doorway.

The garage door system provided herein includes a plurality of panel members. Conventional panels of a garage door typically have an exterior surface of a sheet metal, such as aluminum, steel, or combinations thereof bonded to a central core material, such as an expanded foam. While panels having an exterior surface of a sheet metal can be used as the panels of the door system provided herein, it is preferred that the panels include a more lightweight exterior surface material, such as a thermoplastic resin, or resin reinforced fiberglass, or carbon-fiber-reinforced plastics, such as epoxide resin based carbon fiber-reinforced plastics, or combinations or composites thereof. Exemplary thermoplastic resins include acrylonitrile butadiene styrene copolymer (ABS), polycarbonate Acrylonitrile butadiene styrene copolymer (PC/ABS), polyether-ether-ketone (PEEK), polyetherketone ketone (PEKK), polyethylenimine (PEI), polypropylene (PP), polyphenylene sulfide (PPS), polyvinyl chloride (PVC), and thermoplastic olefin (TPO). A benefit to using plastics and resins is their light weight and the ease with which the panels can be made. The panels can be made by any desirable method, such as injection molding.

The panels can include a surface coating. The surface coating can be selected to provide damage and weather protection to the panel, such as resistance to abrasions, scratches and dents, or to improve structural integrity to the panels, or both. The surface coating can include an abrasion-resistant polymer, such as a thermoplastic elastomer, such as a thermoplastic vulcanizate (e.g., SANTOPRENE® thermoplastic vulcanizate from ExxonMobil Corporation). The surface coating can include an aromatic polyurea/polyurethane hybrid elastomer system (e.g., Line-X® brand elastomeric protective coating). The surface coating can be applied to both sides of the panel, or only to the side of the panel facing the outside environment. Including the surface coating can increase the structural integrity of the panel without significantly increasing the total thickness of the panel. The surface coating can be applied to the panel by spraying, dipping, or any other form of liquid application methods.

The panel member can be manufactured in segments. For example, a first face of the panel and a second face of a panel can be separately manufactured. The first face of the panel can include edges about the perimeter of the panel. An insulating material can be applied to the first face of the panel, being contained by the edges about the perimeter of the panel. The second face of the panel then can be joined to the first face to result in a finished panel. The first and second faces of the panel can be designed so that they can be joined by press fit or snap fit, or can be joined using mechanical fastening (bolts, rivets, screws), ultrasonic welding, heat welding, inductive welding, vibration welding, solvent welding, adhesives or combinations thereof.

Any high efficiency insulating material can be included within the panel. An expanded polystyrene foam, a polyurethane foam, aerogel (such as Pyrogel® aerogel insulation, which is a silica aerogel reinforced with glass fiber) or combinations thereof can be used. In some configurations, the insulating material comprises an aerogel. A spray foam material can be combined with insulation microspheres (e.g., see U.S. Pat. No. 5,500,287 (Henderson, 1996); and U.S. Pat. No. 5,713,974 (Martin et al., 1998)) or vacuum insulated panels (VIPs) also can be included (e.g., see U.S. Pat. No. 4,726,974 (Nowobilski et al., 1988); U.S. Pat. No. 5,107,649 (Benson et al., 1992); U.S. Pat. No. 5,175,975 (Benson et al., 1993); U.S. Pat. No. 5,273,801 (Barry et al., 1993); U.S. Pat. No. 6,010,762 (Smith et al., 2000); U.S. Pat. No. 8,956,710 (Jang et al., 2015); and U.S. Pat. No. 9,523,460 (Lee et al., 2016)) or combinations thereof. By using a high efficiency insulating material, a thin, lightweight panel can be constructed that still provides sufficient insulation to prevent heat loss from the building in the winter and heat gain in the building in the summer. The insulating material can reduce the transmission of thermal energy or sound energy or both. The thermally insulating materials can be present as a single layer, or as multiple layers within the panel. Each panel can be configured to have thermal resistivity to heat loss. The panels are made of tough material with high yield strength. The panels are resistant to environmental forces such as sunlight, corrosion, moisture and humidity. The panels can have a layered composite construction, with different materials layered during fabrication of the panel. The panels can be fabricated so that the finished panel has no visible seams. The panels can be fabricated from a combination of materials that results in a lightweight panel, compared to a traditional garage door panel having a metal skin and dense foam core.

The insulating material can constitute the core of the panel. The core can have a honeycomb design (e.g., see U.S. Pat. No. 4,294,055 (Andresen, 1981) and U.S. Pat. No. 5,445,208 (Shaner et al., 1995)). The core can be affixed to and unitize the two face surfaces of the panel member to make the panel member a single unit with a rigid lightweight structure. The core can be affixed, for example, by using an adhesive that can bond the expanded polymeric material or insulating material to the interior facing face surfaces of the panel member. The core can provide structural stability to the panel. The core also allows the panel to be lighter than a panel of similar dimensions containing a wooden core.

The door panels can be configured to exhibit impact resistance, such as from high speed projectiles. Such high speed projectiles can include debris accelerated by winds, such as hurricane force winds, which can drive debris at speeds of about 50 feet per second or more. Rocks or other debris thrown from a lawnmower can be accelerated to speeds of about 200 miles per hour or more. The wind generated by the blades of a prop plane as it taxis can launch stones and debris as shrapnel. Bullets can reach speeds of 300-500 m/s or more. Shrapnel from a catastrophic failure of a lawnmower, a car engine or an airplane engine can, depending upon the distance from the door, reach speeds of about 1,000 m/s or more. Although the door panels may become dented, the panels can minimize or prevent entry of the projectiles into the garage area. In the case of extremely high speed projectiles, even if the projectile can penetrate and breach the panel, the panel can significantly slow the projectile so that is either travels a shorter distance within the garage area or causes significantly less damage upon impact with an object within the garage.

The core of the panel can include a shrapnel slowing material. Examples include an aramid material or a para-aramid material, such as kevlar, boron carbide tiles, carbon fiber composite materials, ballistic nylon, ballistic fiberglass, ballistic polyethylene composite (e.g., containing an Ultra High Molecular Weight Polyethylene (UHMWPE), such as Spectra® fiber from Honeywell International Inc., Morristown, N.J.), carbon fiber with Dyneema® UHMWPE fiber (DSM Dyneema B.V., Stanely, N.C.) ceramic tiles, or a combination thereof.

Each panel member typically has two horizontal edges (short edges) and two vertical edges (long edges). A panel member can have two face surfaces, a core, a first vertical long edge containing a recessed groove, and an opposite second vertical long edge containing a tongue portion extending outwardly from the panel. The recessed groove of the first vertical edge can act as a mortise, and the tongue portion of the second vertical edge can act as a tenon. The recessed groove of one panel is sufficiently deep relative to the tongue portion of a second panel to receive the tongue portion of the second panel and thereby join the first panel to the second panel.

A panel member can have two face surfaces, a core, a first vertical long edge containing a positive of a half-lap joint extending outwardly from the panel, and an opposite second vertical long edge containing a negative of a half-lap joint, which can receive the positive half-lap joint of another panel. When adjacent panels are brought together upon closing the door, the extended positive half-lap joint of one panel fits into the cutaway negative half-lap joint of the adjoining panel, thereby joining the first panel to the second panel.

Each panel member can be independent of other panel members. Adjacent panel members can be joined together with a hinge that allows the panels to rotate about each other in an accordion fashion. One or more hinges can connect adjacent panel members. The hinge(s) can be placed and/or configured so that the adjacent panel members can be positioned so that the face surface of one panel can be adjacent to the face surface of another panel.

The recessed groove or the negative half-lap joint of the panel member can include a compressible elastomeric material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material can be configured so that it does not interfere with the nesting or interfitting relationship between the tongue portion of one panel and the recessed groove or another panel, or the interfitting of the positive half-lap joint of one panel and the negative half-lap joint of another panel. When present, the compressible elastomeric material can be arranged to that it does not interfere with the ability of the respective panels to pivot or rock relative to one another. The elastomeric material can allow some movement of the interconnected panels without allowing the passage of air, dirt, dust, insects or pests through the interconnected panels.

The tongue portion and the recessed groove can have any complementary shape that allows the recessed groove of one panel member to receive the tongue portion of another panel. Exemplary shapes include a rectangular open mortise, a tapered mortise, and a curved bottom open mortise having a rounded bottom or U-shape.

The intermeshing of the tongue and groove of two panels or the positive and negative half-lap joints of two panels can bridge sheer forces, tensile forces and torsional stress between the panels across the intermeshing joint. The intermeshing of the joints can stabilizes the panels relative to each other. The interlocked panels exhibit substantial resistance to bending, for example, when subjected to high wind loading.

The panel can include one or more windows. The windows can allow passage of light through the door when in the closed position, while maintaining an air-tight seal. The window can be of any transparent material. Examples include glass, acrylic and polycarbonate. The window can be constructed to have a transparent material, such as glass, present in a single layer, or a plurality of layers. In some configurations, at least two layers of transparent material are present, separated by a space. The space between the two layers of transparent material can be filled with a gas. The gas can be an inert gas, such as argon. The window material, such as glass, can be coated with one or more transparent metal oxide layers that can reflect selected wavelengths of electromagnetic radiation. In some configurations, the window material can reflect infrared electromagnetic radiation. In some configurations, the window material can reflect ultraviolet electromagnetic radiation. In some configurations, at least two transparent material layers are present, and an interlayer of polymer film is present between the two transparent material layers, forming a laminated transparent material. The polymer film can be of any polymeric material, such as polyvinylbutyral (PVB), ethylene vinyl acetate (EVA).

The face surfaces positioned toward the exterior environment or toward the interior of the building or both can include a decorative design or embossment. The embossments can be of any desired design or configuration consistent with the aesthetic appearance which is to be achieved. For example, the face surfaces can be embossed with a wood-grain pattern to simulate the appearance of wood. Because the panels are modular and the face surfaces are connected to each other during manufacture, the face surfaces can accommodate the aesthetic style that the customer desires. Because panel members are readily interchangeable, each individual panel can have the same or a different decorative design or embossment. Each panel also can have one decorative design or embossment on one side and a different decorative design or embossment on the other side. Such an arrangement can allow for an appealing visual surface on both the exterior side and interior side of the door system. This modular design allows the customer to select an aesthetic that can result in the door having a different outside appearance compared to the inside appearance. Each panel can include recessed sections, or raised sections, or combinations thereof.

In some configurations, the outermost faces can be configured to accept interchangeable covers to allow easy change the aesthetic look of the door from either side. The covers are attached using fasteners that allow the panels to be detached and changed by the customer. An exemplary fastener is a screw or snap-fit fastener. The cover can be made to have the appearance of any desired material, such as wood, granite, brick or stone.

Any one, or combination of, or all, exterior surfaces of the panel member can be coated with a finishing coating. The finishing coating can be applied to the surface coating. The finishing coating can include a paint, a pigment or a combination thereof. The finishing coating can provide an aesthetic appearance.

Each panel can have a thickness of from about 0.5 to about 3 inches. Each panel can have a thickness of 2 inches or less, or 1 inch or less. In some applications, a panel thickness of from about 1 to about 2 inches is preferred. The height of each panel can be selected for the size of the opening to be sealed. The height of the panels can correspond to the size of any entryway, such as a residential garage. The height of the doorway opening of typical garages in the U.S. typically is seven or eight feet in height.

The width of each panel can be selected to provide the desired aesthetic effect as long as the panels when closed completely cover the opening to be sealed. For example, the doorway opening of a typical single-car garage in the U.S. is about eight feet wide, and the doorway opening of a typical two-car garage in the U.S. is about sixteen feet wide. Panels having a width of from 6 inches to 3 feet can be used. For example, individual panels can be selected to have a width of 0.5 foot, or 1 foot, or 1.5 feet, or 2 feet, or 2.5 feet or 3 feet. The panels can be sized so that the total width of the door includes an extra 0.5 to 5 inches on each end to make sure that a complete seal is formed between the closed door and the sealing member around the opening of the structure, such as a doorway of a garage. The panels can be of the same width, or panels having different width can be used. Typically, panels having a width of from 1 foot to 2 feet are used.

A plurality of panels form a door. Typically, from 4 to 8 panels can be interconnected to form the door of a typical single-car garage in the U.S., depending on the width of the panels selected. When in the open position, the panels can be stacked against each other, in a storage compartment either on one side of the opening (when the door opens from one side) or on each side of the opening (when the door opens from the middle). When opened, the panels of the door clear the doorway opening, providing access to the interior of the structure, such as a garage.

The panels are contained in the moveable frame. The frame typically is larger than the doorway opening so that when the frame advances to have the panels engage with the sealing member around the doorway opening, the panels of the door come into contact with a sealing member attached to the doorway opening and the frame does not interfere with the engagement of the panels with the sealing member affixed about the opening.

Sealing Member

The sealing member can include any compressible material that is reversibly deformable and conforms in shape to the surface of an object brought into contact with the sealing member. The sealing member typically includes an elastomeric compressible material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. The sealing member can include sponge rubber. The sealing member can include a flexible strip of plastic resins. The sealing member can be hollow. The sealing member can be a resilient semi-circular strip of elastomeric compressible material. The sealing member can include a foamed plastic, such as a closed-cell polyethylene foam. The sealing member can include a horizontally disposed elastomeric reservoir containing a quantity of fluid secured to a header above the doorway opening and spaced tubular elastomeric members secured at each side of the doorway opening of the building structure, where fluid forced into the tubular members extend them into sealing contact with the side edges of the panels of the door (see U.S. Pat. No. 4,250,941 (McNally, 1981)).

The cross-section of the sealing member can be of any shape, with a circular or semi-circular shape being typical. When the sealing member has a solid (filled) circular cross-section, the sealing member has the shape of a solid cylinder or rod. The sealing member can have a hollow aperture formed in the interior of the sealing member that extends the length of the material. When this aperture interior is cylindrical in shape it typically results in a sealing member with an annular cross-section, that is, the sealing member is in tubular form, i.e., in the shape of an annular cylinder. The sealing member should have sufficient resiliency and compressibility to return to its original shape after the application of compression forces, e.g., when the frame engages the panels with the sealing member.

A sealing member can be attached to the top and side edges of the doorway opening using any appropriate fasteners. Typical fasteners include screws, nails, clips, clamps and adhesives, such as glue or epoxy. A sealing member also can be included at the bottom of each panel. The sealing member can be compressible and forms a seal when the door is moved into the closed position.

Having the door open sideways can minimizes air disturbances that can result in dust, insects, or debris being brought into the building space, such as the garage. By using a pivotal connection, an outward sweeping motion can be utilized to sweep the inside floor area of the garage in front of the panels as they close. As the doors shut, the outward moving action created at the pivot point will actually push air and other substances out, which can carry with it dust, dirt or other debris. Bristles or other material can be added to the bottom of the panels to brush material from in front of the panels to outside of the garage as the panels close.

When configured to be dual sided (opening from the middle to that a portion of the door in the open position is on one side of the opening and the other portion of the door if on the other side of the opening), one side of the garage door can be opened separately from the other. The door can be configured to be easily moved manually, similar to a sliding glass door. In such configurations, the system can include a deadbolt type lock or other locking mechanism between the two door portions, enhancing safety and protection from invaders. An airtight seal can created between every panel, especially the two end panels of each door section which are brought together in the center to close the door.

Two or more panels of the door or door segment (in the case of a dual sided configuration) can be connected by a pivot point, such as a hinge. Instead of being connected by a hinge or other pivotal connector, the panels also can be configured to rotate axially before moving laterally to open the door. Axial rotation can be achieved by positioning a panel of the door on spindles on which the panel can rotate. The spindles can be located at the top and bottom of the panel. The spindles can be located at one edge of the panel, or can be located near the center of the panel. Each panel can be configured to rotate axially independent of other door panels. Such independent axial rotation of a single panel can allow a user to open a specific panel fully or partially. With such configuration, a person leaving by foot doesn't have to wait for the garage door to fully open in order to exit, as rotation of the panel provides sufficient space for transit. In some configurations, each panel can include a motor that drives the opening or closing of the panel, providing the capability of mechanically opening only one panel at a time, or all panels at the same time.

To mitigate noise during operation, one or more acoustic dampers or acoustic dissipaters can be included. For example, each panel can include an acoustic damper within the panel. The acoustic damper can be the insulating material, or in addition to the insulating material. A viscoelastic polymer can be used as a layer within the composite panel to act as an acoustic damper or dissipater. Examples include mass-loaded vinyl, nitrile rubber, rubber-modified epoxy resin, carboxy-terminated butadiene nitrile, and butadiene-acrylonitrile copolymer rubber. Similar materials can be used to acoustically insulate the box housing the motor(s). Low-noise motors also can be used to mitigate a major source of the noise generated during opening and closing of the door. In some configurations, a toothed non-metal belt is used for linear actuation instead of a screw or chain to reduce noise. To minimize vibration-generated noise, some configurations minimize the use of metal parts.

Tracks

The door systems provided herein open horizontally instead of vertically. The door frame system includes an upper and a lower track, which accommodates spindles in the panel elements of the door, and can guide the panels as they are opened and closed. In some configurations, an upper track extends from one side wall of the garage, over and across an opening defining a garage vehicle entrance into the garage, to the other side wall of the garage. The system includes a lower track attached to the floor of the garage, and extends generally parallel to the upper track from the one side wall to the other side wall within the garage. The door, comprising a plurality of panels, is connected to the tracks so as to be movable along a length of the tracks. Typically, each of the panels is connected to the upper and lower tracks, such as by spindles, which are accommodated within the tracks and allow horizontal movement of the panels to open and close the opening of the garage.

The garage door is horizontally moveable along the tracks, such as via a chain-driven or belt-driven motor mechanism, from a closed position that can seal the garage vehicle entrance of the garage, to an open position which provides ingress and egress from the garage vehicle entrance. The panels of the door collapse against each other, and can be stacked and disposed adjacent to one or both side walls of the garage. The panels can be stacked in a recess or niche, such that the panels form a stack that takes up a minimum of space. The panels can be independent of each other, or can be configured to be pivotally interconnected with one another. The panels are vertically oriented move along the tracks to open and close the door in a horizontal, as opposed to a vertical, movement. In order to stack and store the panels, a branch rail from a main track at the ceiling, for example at an angle of from 60-90° relative to the main track, can be provided to form a guide rail, which can extends parallel to the upper track.

The panels are connected to a top and bottom track at a point and move axially along it. Each panel can include a top spindle that can interact with the top track, and a bottom spindle that can interact with the bottom track. The panels can be configured to accommodate a length of the spindle within the panel, so that the total exposed length of the spindle can vary depending on the position of the frame (extended or retracted position). The spindle can be jointed, so as to allow the spindle to remain connected with the track as the frame is positioned from an extended to a retracted position.

The spindles can include rollers or wheels that allow the door panels to move within the track. The rollers or wheels can be metal, nylon, plastic or wooden. The rollers can include an elastomeric coating, a plastic coating, or a polymer coating, such as a Teflon or nylon coating. Each panel element of the garage door can include one or more upper wheel assemblies extending from upper edges of the panels and operably engaged with the upper track. Similarly, one or more lower wheel assemblies can extend from lower edges of the panels and can be operably engaged with the lower track.

In some embodiments, the multiple rails can be included for directing positioning of the panels as the door is opened or closed. The upper track extends horizontally above the opening of the garage and is reversibly connected to the garage. A first guide rail can be included to extend in a substantially horizontal direction, adjoining the upper track, and can be disposed at an angle of from about 60-90 degrees relative to the upper track. A second guide rail can be included to extend horizontally, adjoining the first guide rail, and can be disposed parallel relative to the upper track. A first movable trolley can be included, supported and guided by the upper track. A second movable trolley can be included, supported and guided by the first guide rail. A third movable trolley can be included, supported and guided by the second guide rail. A first coupling device can be attached to the first movable trolley. A second coupling device can be attached to the second movable trolley. A third coupling device can be attached to the third movable trolley. A door panel can be supportable on one of the upper track, the upper track and the first guide rail, and the upper track and the second guide rail. A first rolling crosspiece can be attached to the door panel at an upper end of the panel near a first side and engageable by each of the coupling devices. A second rolling crosspiece can be attached to the door panel at the upper end of the panel near a second side and can be engageable by the first coupling device. The distance of the first rolling crosspiece from the second rolling crosspiece can be selected to correspond to the distance between the upper track and the second guide rail.

A second door panel can be supported on one of the upper track, the upper track and the first guide rail, and the upper track and the second guide rail. A third rolling crosspiece can be attached to the second door panel at an upper end near a first side and engageable by each one of the coupling devices. A fourth rolling crosspiece can be attached to the second door panel at the upper end near a second side and engageable by the first coupling device. The distance of the first rolling crosspiece from the second rolling crosspiece can be selected to correspond to the distance between the upper track and the second guide rail. A first coupling element can be provided at the first rolling crosspiece and being engageable by each of the coupling devices. A second coupling element can be provided at the second rolling crosspiece and engageable by the first coupling device. A coupling structure can protrude from the door panel. The coupling at the rolling crosspiece of the door panels can be accomplished via the coupling structure protruding from the door panels.

A channel can be contained in the upper track. A first guide channel can be furnished in the first guide rail. A second guide channel can be furnished in the second guide rail. A first gear rack can be provided in the upper track. A second gear rack can be provided in the first guide channel. A third gear rack can be provided in the second guide channel. A first gear wheel can be attached to the first movable trolley. A second gear wheel can be attached to the second movable trolley. A third gear wheel can be attached to the third movable trolley. A first electric motor can be attached to the first movable trolley and can be connected to the first gear wheel for driving the first gear wheel along the first gear rack. A second electric motor can be attached to the second movable trolley and can be connected to the second gear wheel for driving the second gear wheel along the second gear rack. A third electric motor can be attached to the third movable trolley and be connected to the third gear wheel for driving the third gear wheel along the third rack.

A first coupling can be disposed at a first end of the first movable trolley. A second coupling can be disposed at a second end of the first movable trolley. A third coupling can be disposed at a first end of the second movable trolley. A fourth coupling can be disposed at a second end of the second movable trolley. A fifth coupling can be disposed at a first end of the third movable trolley. A sixth coupling can be disposed at a second end of the third movable trolley. A horizontally shiftable support can be provided for the first rolling crosspiece of the door panel and disposed at the door panel. The sliding of the first rolling crosspiece during the mounting or demounting of the door panel for the upper track or guide rail can effect a moving out and a moving in, respectively, of the door panel.

In some embodiments, the movable trolley of the upper track interacts with the upper spindle of a door panel, and facing the side wall of the garage where the panels are to be stacked, moves this spindle up to the branch region of the first guide rail, where a decoupling is performed in order to continue to drive the required distance in order to allow the spindle to traverse to the first guide rail, and the spindle, which was previously decoupled from the movable trolley of the upper track in order to pull the support member into the branch first guide rail until the door panel, disposed opposite the upper track, assumes an angled position (preferably more than 30°) in order to decouple it. The movable trolley of the upper track moves in order to couple the second spindle support of the same door panel and drives the second spindle up to the branching point, where the advancing of the first spindle up to the connection point at an angle of 90° between the branch guide rail and the guide rail running parallel to the upper track is performed. The movable trolley of the first guide rail, running parallel to the main upper track, couples the first spindle support and pulls the door panel, in cooperation with the movable trolley of the upper track, into a cross position relative to the course of the main upper track, in the direction of the region where the door panels are to be stored, where two movable trolleys decouple the spindle support members in one position, which position is determined by the door panels that have been previously placed into the storage region.

The movable trolleys travel back to their starting positions for moving the next door panel in the direction of the storage area. The movable trolleys allow a low-noise drive with extremely precise and quiet coupling and decoupling processes, which can be controlled electronically and/or through microswitches, actuated along the running course through projections, furnished along the running course. The movable trolleys can operate in two directions by pulling and/or pushing the spindle support members of the door panels. The drive system can include a movable trolley in each straight-line section of the guide rails. For example, one movable trolley can be included to move along the upper track. A second movable trolley can be included to move along the first branch guide rail, which branch guide rail forms an angle of 60-90° with the upper track. A third movable trolley can be included to move along the second guide rail that runs parallel to the upper rail. The motion, timing and direction of each of the movable trolleys can be coordinated with a control program.

In configurations where the door opening is to be maximized, e.g., clearance of the opening must be assured, such as in an airplane hangar, the frame of the door system can be movably coupled to a fixed ceiling rail having a U-shape. The panels move from the opening in the upper track connected to the ceiling rail and are moved toward the back of the building along the side walls, thereby eliminating any possible interference the panels of the open door could otherwise cause if stacked on one side or both sides of the door opening.

Additional Elements

The door systems provided herein can include additional elements. In some configurations, the door system can include a computer module for partial or complete automation of the system. The computer module can include a computer in communication with and/or in control of any part of the door system. The computer module can communicate with a control system to automate or operate the opening and closing of the door. The control panel can be configured to operate lights, mechanical components, operating mechanisms, a touch panel, and automatic closing and locking mechanisms. In the systems provided herein, the computer module can include a non-transitory computer-readable storage medium having a computer-readable program embodied therein for directing operation of the door system and/or any component of the system.

The door system also can include one or more sensors. Exemplary sensors include infrared tripping sensors, variable resistance sensors, thermocouples, carbon monoxide detectors, and smoke detectors. The system also can include monitors for airborne contaminates, such as dust or particulate matter and natural gas. Sensors can be connected to the sealing element, and can alert the computer module when the sealing element needs to be cleaned in order to keep it air tight. Timers can be included to measure the time the door is in the open position, and can be in communication with the control panel, which can send a signal to notify the homeowner (such as by sending a text or calling a cellular phone) or trip an alarm if the door has been left in the open position for an extended period of time, especially at night. The door system also can be configured so that after a certain amount of time has expired, the garage door can automatically close as long as nothing is obstructing the pathway of the doors.

Visual or auditory alarms or combinations thereof can be attached to or in communication with the sensors, and activate if any detectors or sensors are tripped. Smart audio speakers with Bluetooth capability can allow wireless placement of the speakers anywhere within the garage to sound alarms.

The system can be configured to include sensors that can detect movement, such as to determine the difference between a car entering or exiting the opening, or a static object in the path of the door system. The system can provide visual warnings in response to the detection. For example, an LED lighting system can be configured to light up or and remain lit at one wavelength, e.g., emitting an orange light, when a car is slowly moving through the opening within the closing zone of the door system. Once the car has made it through the closing zone of the door system, the LED lights emit light of a different color, such as green, signaling that it is safe for the door to close. If a static object is in the closing path of the door system, the lights can be configured to emit light of a different color, such as red, signifying that the user must clear the doorway of the object obstructing the path of the doors in order for the door system to close the doors. Similar auditory “alarms” or signals are available in current technologies, but visual sensors can elicit a stronger response in humans than auditory alarms, creating a more effective manner of communication between the door and the user.

Instead of, or in addition to, visual signals, auditory alarms also can be included in the system. Different auditory signals can be used for each sensor, resulting in different auditory responses for a smoke alarm than a carbon monoxide indicator. The door system can be configured to include voice technology systems as auditory alarms, such as to warn users of obstructions in the door path, of increased carbon monoxide levels, or the detection of smoke in the garage. The door system can be configured so that a user can customize a variety of alarm noises to be associated with different sensors. All alarm sensors and triggers can be designed to be in accord with CFR standards.

The control system can be in communication with the sensors, and work in conjunction with the sensors. The control system can be navigated by use of a touch panel in communication with the computer module. The control panel can include a color-coded light indicating system to indicate the status of the system, and the position of the door, and the status of one or more of the sensors. For example, the lighting system can include a blinking function that is green, yellow, or red depending on the readiness for the system to close the door. The computer module also can record usage history information, such as for safety or security reasons.

The control panel can be located within the building. The control panel automatically can synchronize with the computer module to control the door system operational parameters. The control panel can include a screen that can display the status of the system and any attached sensors. The screen also can be configured to display indoor temperature and relative humidity, and outdoor weather characteristics, such as wind speed, relative humidity, temperature, and barometric pressure. The control panel can include touch screen with a NEMA 4 enclosure type, and be configured to prevent ingress of moisture, dirt, or air. The system frame can be configured to house the control panel. Multiple control panels can be configured to work with the system, allowing remote access and control or observation of the system. The system can be configured so that a user can open, lock, and switch between electronic and manual use of the door, and can do so remotely using a cellular phone. The system also can be configured to include voice recognition software to allow operation via voice command. By integrating the voice recognition software with control panel, voice commands can be used for all electronic functions of the system.

The garage door can be configured to include a smart system that allows for user customizability. The smart system can connect the door system provided herein to smart house products such as AMAZON ECHO and GOOGLE HOME. In addition, it can be configured to have user specific opening codes, or configured to be interactive with a cellular phone application. The door system can be configured to that its smart system can connect to a Wi-Fi, such as for communication with a cellular phone application, or to receive software updates. The system also can be configured to send a notification to the manufacturer of any equipment failure or malfunction to allow for automatic contacting of servicing personnel, or to alert a homeowner of the malfunction. The computer module can be configured to allows easy update of hardware.

The door system can include an alternate power option, such as backup power generator, solar panels, or battery system, that can be used in case of interruption of utility services. The door system can include a ventilation system that can move air out of the garage or enclosed space or introduce fresh air into the garage or enclosed space. This can allow the door system to monitor and modulate the climate within the garage. The ventilation system can include a filtered fan or blower, which allows air movement but prevents particulate matter from being introduced into the garage by the fan or blower. The ventilation system can include an air freshening component to keep the garage space smelling fresh.

The door system can be configured to include a blower system. For example, the bottom track can be configured to contain a piping system attached to an air blower. Holes in the piping system, alone or in combination with the ability to rotate the pipe of the piping system to reposition the orientation of the holes with respect to the system, can be used to blow air laterally or vertically. When configured to blow air laterally, the blower system can move dust, leaves, and moisture away from the door. When configured to blow air vertically, the blower system can be used to blow air toward the bottom of a car as it passes over the bottom track, blowing away dirt and debris, and when raining, and to help prevent excess water from entering the garage.

The door system can be manufactured and sold as a single unit. All components of the door system, regardless of the design, can be prepackaged, and where appropriate, incorporated into the frame. The frame easily can installed in the building opening.

Door Operating Mechanism

Any door operating mechanism to open and close the door can be included in the systems provided herein. A variety of operating mechanisms have been disclosed and used in the past for opening doors horizontally (e.g., see U.S. Pat. No. 4,963,809 (Shingu et al., 1990); U.S. Pat. No. 5,267,597 (Green, 1993); U.S. Pat. No. 5,369,912 (Ginzel et al, 1994); U.S. Pat. No. 5,425,409 (Guia, 1995); and U.S. Pat. No. 8,156,992 (Diaz et al, 2012)). The door operating mechanism can include a mechanical opener, an electromechanical opener, an electrical opener, a hydraulic opener, a pneumatic opener or combinations thereof. The door operating mechanism can include a motor, such as a step motor, in combination with any one or more of belts, chains, pulleys or gears. The door operating mechanism can include a combination of a motor, a pulley, a synchronous drive member, a carriage, and an operator. The pulley can be coupled to and driven by the motor. The synchronous drive member can be coupled to the pulley and can be driven by the pulley. The carriage can be connected to the synchronous drive member and to a edge of a panel of the garage door. The operator can be coupled to the motor and can control the motor. The door operating system can include exposed or enclosed chain or belt systems, and internal or external gear systems. The door operating mechanism can include an electric motor and a screw-driven longitudinally moving shuttle. The door operating mechanism can include a screw or chain driven moving mechanism. An electric motor can be connected to the screw or chain mechanism.

The door operating mechanism can include a carriage assembly connected to at least one panel of the door and a flexible drive cable, belt or chain that when activated moves the carriage to open and close the door. The door operating mechanism can include a rotatable motor driven member mounted on the frame, which motor driven member drives a first cable, belt or chain; a rotatable shaft having opposed ends mounting the driven member for rotation at one of the ends of the shaft, the shaft being mounted in at least one bearing device mounted on the frame; a rotatable drive member mounted at the other of the ends of the shaft; a second flexible cable, belt or chain mounted on the rotatable drive member which when activated rotates the shaft and driven member; and an electric drive motor member rotatably mounted on an end of the frame and connected to the second flexible cable, belt or chain, where when the drive motor is activated it moves the second flexible cable, belt or chain, rotates the drive member, shaft and driven member to move the first flexible cable, belt or chain and the carriage assembly to open and close the door. The drive and driven members can be bicycle-type sprockets mounted on the drive shaft and bicycle-type chains that engage the sprockets.

The door operating mechanism can include a shaft with a pair of spaced apart helical or non-helical or side drums mounted on the shaft, and a cable, belt or chain connecting each helical or non-helical or side drum to an edge of a panel of door. A cable drum can be mounted proximate to each end of the shaft and outside of the side drums. A bearing plate can be used to separate each side drum from the respective cable drum. The door operating mechanism can include a standard electric door motor or screw drive. It will be understood by those skilled in the art that it is not necessary for the door operating mechanism to be powered by a motor in order to operate, the door can be moved longitudinally to open or close any other suitable mechanism, including a hydraulic opener or a pneumatic opener, as well as manually. The drums can be installed on the shaft by any suitable mechanism, such as threaded bolts or screws that are screwed inwardly until they engage and lock the drums onto the shaft. This allows the drums to rotate with the shaft. The drums and shaft can be manufactured from steel or aluminum or any other suitable material or alloy. It will be understood by those skilled in the art, that it is not necessary to utilize a shaft that extends across the entire width of doorway opening of the structure. It is possible to use two smaller separate shafts to operatively connect each side drum with its respective cable drum.

The door operating mechanism can include a one or more movable trolleys. Each movable trolley can include a gear wheel that can be engaged with a gear track in the upper or lower track. The movable trolley can include an electric motor connected to the gear wheel.

The door operating mechanism can include an electric motor, a chain drive mechanism or drive belt mechanism, and a length of a bicycle-type chain or belt geared to the chain drive mechanism or belt drive mechanism driven by the electric motor. An end of this length of bicycle type chain or belt, as a first chain or first belt, can be mounted around a drive sprocket mounted on a shaft. The shaft can be a length of round steel bar with the drive sprocket and a driven sprocket mounted on each of the ends. The shaft can be of a length to fit the installation space parameters vertically, and typically is mounted perpendicular to the first chain or first belt. The shaft can be mounted above or rearward of the garage doorway opening and garage door. A length of a similar bicycle-type chain or belt, as a second chain or second belt, can be fitted to the driven sprocket at the other end of the shaft and movement and travel of the second chain or second belt can be guided by a traverse rail, forwardly directed towards the top of the garage door. Extending from the end of this second chain or second belt can be a length of cable that is attached to an edge of a panel furthest from the side of the opening. The cable or belt can be attached through a hinged bracket. The door operating mechanism can include a worm drive shaft. The door operating mechanism can include a support platform, a track, a drive chain, and an electrically operated bidirectional drive system.

The door operating mechanism for stacking the individual door panels can include any drive device that can move the door panels along the upper and lower tracks of the frame. The drive device can include a belt, chain or other drive element, which drive element can be supported inside of one of the tracks.

The door operating mechanism can be mounted on the ceiling area of the garage, or on a side wall on beams or supports, or installed on mounts at a height equal to the height of the garage door in its raised position, or can be mounted on the floor area of the garage. The entire mechanism can be configured to be parallel to the garage floor in its fully installed position. The door operating mechanism can be configured so that its cable, belt or chains are parallel to the garage floor and parallel to the tracks of the door system frame.

The system also can include a sealing element attached to the bottom edge of each door. The sealing element can conform to the floor of the lower track, and can accommodate horizontal movement as the door system frame is moved toward or away from the doorway opening. When the door is in the closed position, the sealing element can form an airtight seal between the lower edge of each door panel and the lower track of the frame. The sealing element can be of any elastomeric material. The sealing element can be or contain rubber, polyolefin foam, vinyl, synthetic poly-isoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof.

Exemplary embodiments are described below in conjunction with the accompanying figures. The following description is only illustrative and should not be viewed as limiting.

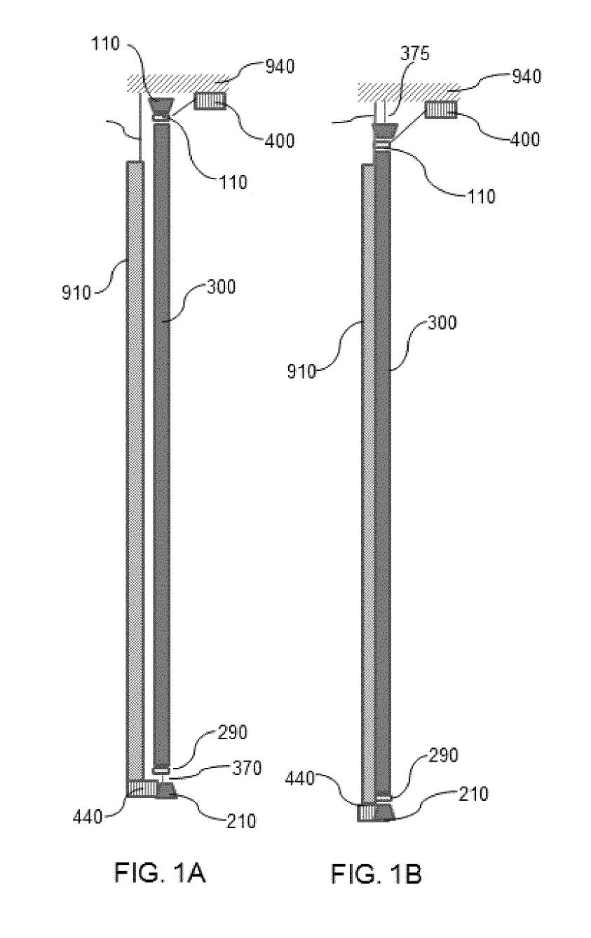

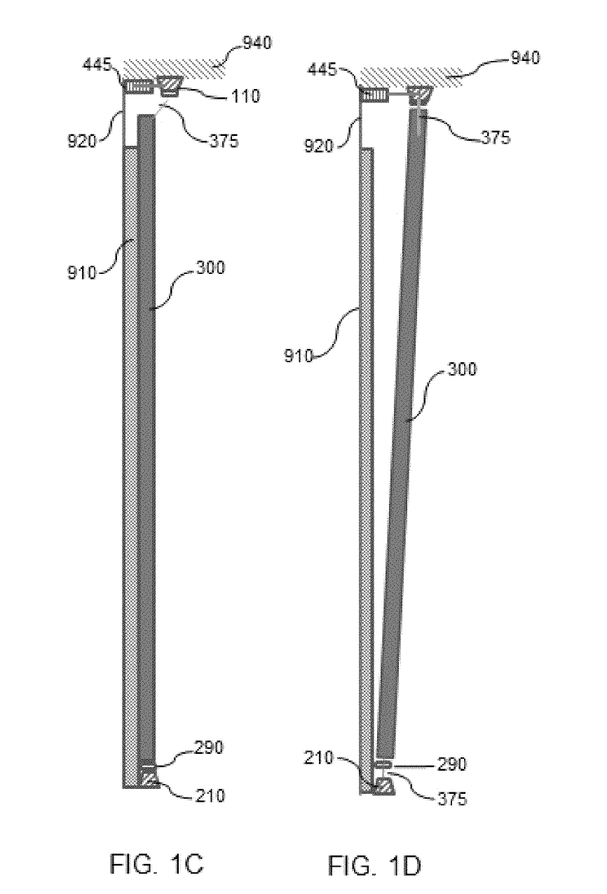

An exemplary door frame system is illustrated in FIGS. 1A and 1B. FIG. 1A is a side view of the system in a state where the door is ready to be opened. FIG. 1B is a side view of the system in a closed state. As can be seen in FIG. 1A, when the door is to be opened, the upper movable connector 400 moves the upper track 110 along the ceiling rail 100 away from the building opening sealing element 910 and upward toward the interior ceiling of the building, such as the ceiling of a garage 940 and away from the header 920 above the building opening. This results in the panels 300 disengaging with the opening sealing element 910 and moving with upper track 110 towards the interior of the building. The action of the upper movable connector 400 also results in the panels 300 being lifted upward so that the floor sealing element 290 at the bottom of each panel clears the lower track 210, minimizing wear to the floor sealing element 290 as the door opens and closes as the panels traverse through lower track 210. The spindle 370 in each panel 300 extends from inside the panel 300 as the panel 300 is raised, maintaining contact between the wheel attached to spindle 370 and the lower track 210. At or about the same time as the upper movable connector is activated, the lower movable connector 440 is activated and moves the lower track 210 along a lower rail away from the building opening. The door panels then can be moved to a storage location on one side of the opening, or to separate storage locations on each side of the opening.

When the door is to be closed, the panels 300 are extended from the storage location(s) to traverse across the opening 900 of the building around which the opening sealing element 910 is located. Once the panels have been fully extended, effectively closing the building opening 900, the movable connector 400 is activated and moves in the opposite direction, moving the upper track 110 towards the building opening 900 and against opening sealing element 910 and downward toward the floor. The action of the movable connector 400 on the upper track 110 results in the upper track 110 moving along the ceiling rail and extending the spring of spring assembly 375 as the panels 300 are positioned toward the opening sealing element 910, and engage firmly with the opening sealing element 910, securely fitting the panels 300 of the door against the opening sealing element 910 to form an airtight seal. At or about the same time, the lower movable connector 440 is activated and moves the lower track 210 along the floor rail toward the building opening 900. The lowering of the panels 300 toward the floor results in the panel sealing elements 290 engaging with the lower track 210 to form an airtight seal.

The frame can be moveably connected to the doorway opening using a plurality of movable connectors 400. The movable connector 400 can include a combination of motor driven threaded member connected to corresponding receiving member. The motor driven threaded members can be attached to the upper track 110 and the corresponding receiving members can be attached to elements of the doorway opening, such as a joist or stud. Conversely, the motor driven threaded members can be attached to elements of the doorway opening, and the corresponding receiving members can be attached to the upper track 110 of the frame. For example, a plurality of metal plates can be fixedly attached to the doorway opening. A metal plate can be located on the interior of the building attached to each vertical beam. In some configurations, each vertical beam of the doorway opening includes two metal plates spaced apart. In some configurations, each vertical beam of the doorway opening include a metal plate near the top of the doorway opening positioned to be connectable to the upper track 110.

Each metal plate can include an internally threaded opening. A threaded member that is engaged with the internally threaded opening in the plate attached to the building is attached to the upper track 110. A motor is attached to the threaded member and when energized can cause the threaded member to rotate. The motor can be in communication with the control panel, which can control the movement of the threaded member. The control panel can control the amount and the direction that the threaded member is rotated by motor. The threaded member can be a screw or bolt. Rotation of the threaded member by the motor in one direction repositions the upper track 110 toward the doorway opening, and rotation of the threaded member by the motor in the opposite direction repositions the upper track 110 away from the doorway opening. For example, rotation of the threaded member by the motor clockwise can reposition the upper track 110 toward the doorway opening, and rotation of the threaded member by the motor counterclockwise can reposition the upper track 110 away from the doorway opening.

Alternatively, rotation of the threaded member by the motor counterclockwise can reposition the upper track 110 toward the doorway opening, and rotation of the threaded member by the motor clockwise can reposition the upper track 110 away from the doorway opening. The motor can be in communication with the computer module, which can include a program to drive the speed and direction of the motor. The control panel can be configured to communicate with the computer module to modulate the power provided to the motor, or regulate the speed and direction and duration of movement of the motor, or permit automatic activation of the motor in response to a signal, or any combination thereof. The invention is not tied to any specific motor or type of motive device.

The threaded member can be a screw or bolt or similar fastener having a screw thread that can engage with the internally threaded opening in metal plate attached to the vertical supports of the door frame. The internally threaded opening can receive the threaded member. The motor can be attached to the frame. The threaded member attached to the frame motor can engage the internally threaded opening in the metal plate to form a threaded engagement between the upper track 110 and the doorway opening by which the upper track 110 moves closer to or further from the doorway opening in response to the rotation of the motor-driven threaded member. A movable sleeve that can extend and retract can be included to shield and protect the threaded member.

The motor can be a conventional direct-current (DC) motor driven by a power control signal, or can be a stepper motor that allows a precise amount of rotation of the threaded member by electronically controlling the number of energizing pulses supplied to the motor. The motor can operate to rotate in the forward and reverse directions. A control circuit can be programmed to control rotation of the motor in the forward and reverse directions in response to an indication that the door is to be opened or closed. The motor can include an electronic control unit in communication with the motor that can be programmed to stop rotation of the motor virtually instantaneously once the upper track 110 has been moved sufficiently toward to doorway opening to seal the doorway opening.

The movable connector 400 can include an electro-mechanical connector, an electric-hydraulic connector, a hydraulic connector, a pneumatic connector, an electro-pneumatic connector, a solenoid valve connector, a mechanical spring connector, or a combination thereof.

Instead of including a plurality of movable connectors on each side of the building opening to move the door system frame toward and away from the building opening, the system can be configured to include a single movable connector on each side of the building opening, in conjunction with an upper spring assembly and a lower spring assembly. An exemplary configuration is shown in FIGS. 1C and 1D. FIG. 1C is a side view of the system in a state where the door is in a closed state. FIG. 1D is a side view of the system ready to be opened.

As can be seen in FIG. 1C, when the door is in the closed position, the panels 300 are extended from the storage location(s) to traverse across the opening of the building around which the opening sealing element 910 is located. Once the panels have been fully extended, effectively closing the building opening, the movable connector 445 is retracted, having moved the upper track 110 towards the header 920 and against opening sealing element 910, the lower spring assembly 375 pulling the panels downward toward to floor. The action of the movable connector 445 on the upper track 110 results in the upper track 110 moving along the ceiling rail and extending the spring of upper spring assembly 375′ as the panels 300 are positioned toward the opening sealing element 910, and engage firmly with the opening sealing element 910, securely fitting the panels 300 of the door against the opening sealing element 910 to form an airtight seal. The lowering of the panels 300 toward to floor by lower spring assembly 375 results in the panel sealing elements 290 engaging with the lower track 210 to form an airtight seal.

As can be seen in FIG. 1D, when the door is to be opened, the movable connector 445 moves the upper track 110 along a ceiling rail away from the building opening, away from sealing element 910 and away from the header 920 above the building opening. This results in the panels 300 disengaging with the sealing element 910 in a zipper-like fashion, disengaging first at the top of the opening and then disengaging downward as the movable connector 445 moves the upper track 110 away from the building opening. The action of the movable connector 445 and the upper spring assembly 375′ also results in the panels 300 being lifted upward so that the floor sealing element 290 at the bottom of each panel clears the lower track 210, minimizing wear to the floor sealing element 290 as the door opens and closes as the panels traverse through lower track 210. Although not shown in the figure, the spindle in each panel extends from inside the panel as the panel is raised, maintaining contact between the wheel attached to spindle and the lower track. The door panels then can be moved to a storage location on one side of the opening, or to separate storage locations on each side of the opening.

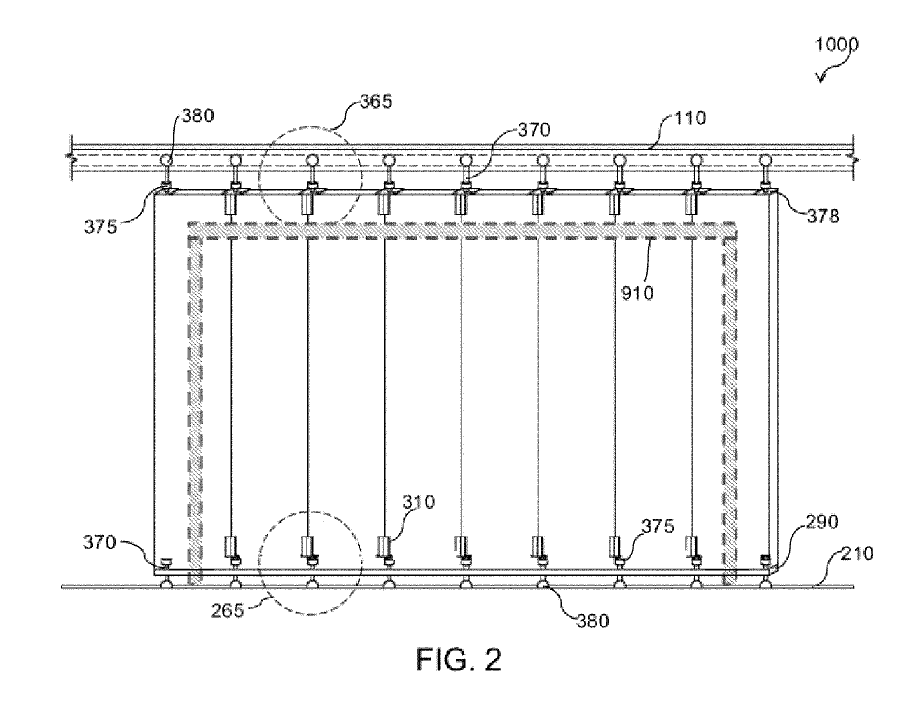

An exemplary view of a closed door system 1000 is shown in FIG. 2. The view is from the inside of the garage looking toward the closed door. The dashed lines illustrate the position of the opening sealing element 910 that is attached to the vertical and horizontal sides of the building opening behind and engaged with panels 300 of the door system 1000. Spindles 370 are shown attached to wheels 380. The spindles 300 can be attached to the panels 300 via spindle supports 378. The upper wheels 380 engage with upper track 110 while the lower wheels 380 engage with lower track 210. Also shown are spring assemblies 375 which allow the spindles 370 of the panels 300 to remain engaged with the upper track 110 and the lower track 210 when the door is moved upward when the movable connector (not shown) activates to open the door, and to allow the door to move downward when the movable connector activates to close the door, allowing floor sealing elements 290 on the end of each panel 300 to engage with lower track 210 to form a seal. Also shown are optional hinges 310 pivotally connecting together panels to form an articulated door 950. Close up view 365 is shown in FIG. 4A in more detail. Close up view 265 is shown in FIG. 4B in more detail.

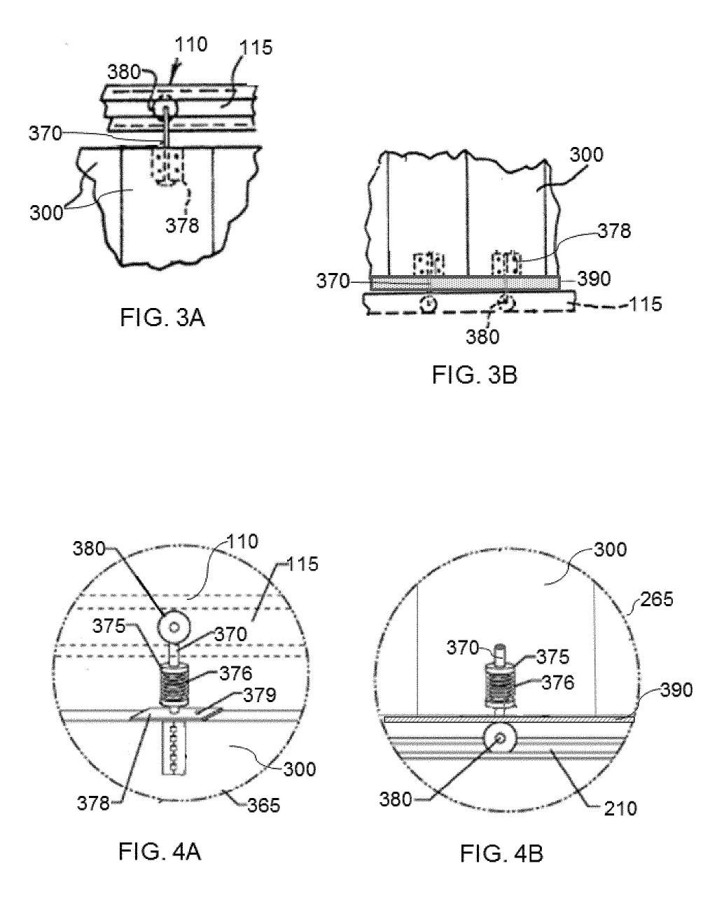

FIGS. 3A and 3B show close up views of the spindles 370 and wheels or rollers 380. As depicted in FIG. 3A, the spindle 370 is attached to a wheel 380 operably engaged with upper track 110. The wheel 380 is contained within groove 115 and can traverse the upper track 110 by moving within groove 115. The spindle 370 is connected to the panel 300 via a spindle support 378, which can be configured to be within the panel, as depicted.

FIG. 3B is a close up view of the bottom of a panel 300 showing spindle 370 attached to the panel 300 via a spindle support 378, configured to be contained within the panel 300. Each panel 300 includes a panel sealing element 390 at the bottom of the panel, which when pressed downwards forms an airtight seal with the lower track 210. The lower track 210 includes a floor sealing element 290 that forms an airtight seal between the floor of the building and the lower track 210. A wheel 380 is attached to a distal end of the spindle 370 and moves within lower track 210.

FIG. 4A is a close up view of another embodiment of the upper portion of a panel 300. In the configuration shown, the spindle support 378 is shown attached to the outside edge of the panel 300 via a fastener 379. The spindle 370 is connected at one end to a spring assembly 375 containing a spring 376. The spindle 370 is connected at the other end to a wheel within groove 115 of upper track 110. The spring assembly 375 allows the panel to up or down, depending on the action of the movable connector 400 (not shown). FIG. 4B shows a close up view of an embodiment of a lower panel 300. As depicted, a spring assembly 375 containing a spring 376 is contained within the panel 300 and is connected to spindle 370. The spindle 370 also is attached to a wheel 380 that is contained in and readily travels within lower track 210. When compressed, the spring assembly 375 allows the wheel 380 to enter into a recess within the panel 300 designed to accommodate the wheel, allowing the panel sealing element 390 to come into contact with the lower track 210 and form and airtight seal.

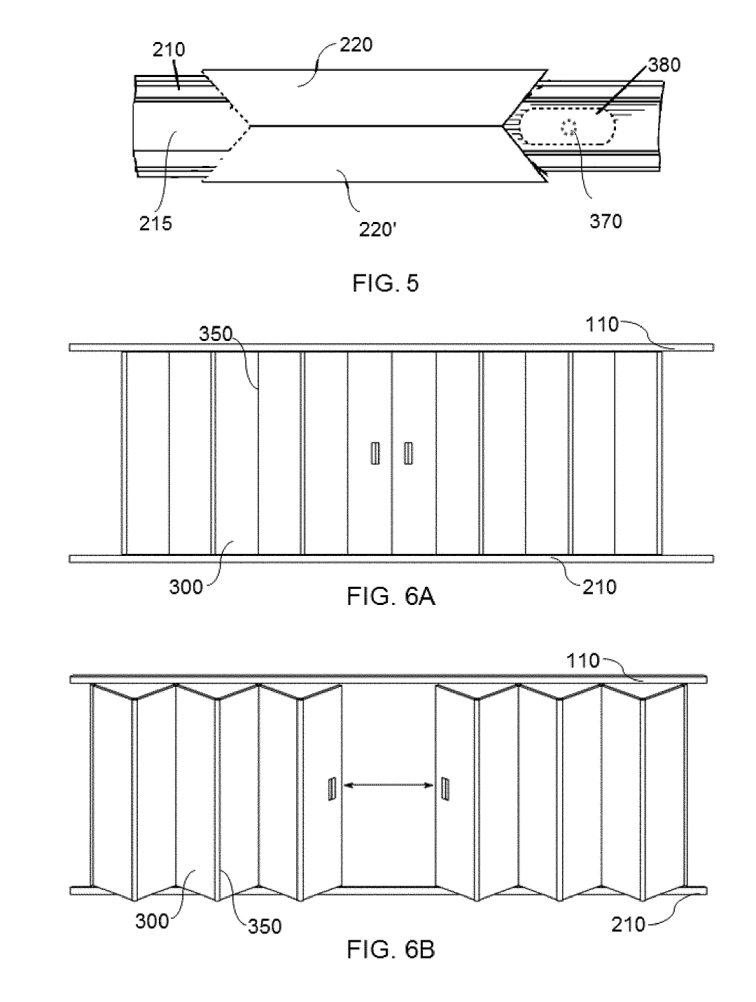

FIG. 5 is an overhead view of the lower track 210. In order to keep dirt and debris from entering the lower track 210, a split elastomeric gasket 220 and 220′ is attached to the upper portion of track 210. The elastomeric gasket 220 and 220′ can be configured to that the wheel 380 can pass beneath the gasket. As spindle 370 attached to wheel 380 comes into contact with the split elastomeric gasket 220 and 220′ at the location of the split, the split elastomeric gasket 220 and 220′ separates to accommodate passage of spindle along the split between elastomeric gasket 220 and 220′ closing behind the spindle as it passes, thereby keeping dirt and debris from entering lower track 210 while allowing easy passage of the wheel 380 and spindle 370 along lower track 210.

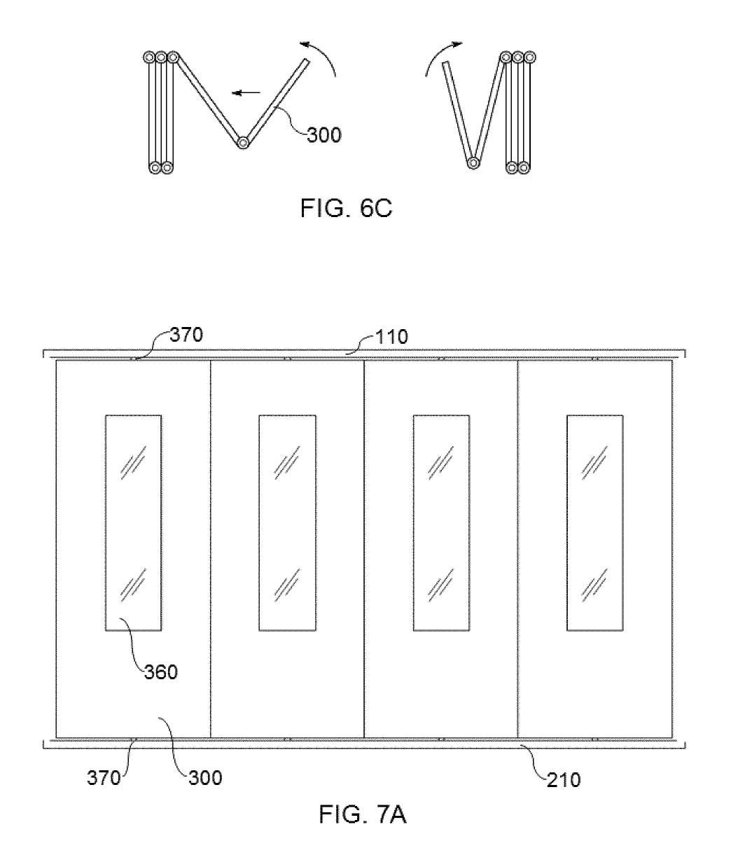

FIGS. 6A and 6B depict a front view looking toward to the garage door. As shown in FIG. 6A, the panels 300 can be configured to include a folding section 350, which can contain a pivoting member, such as a hinge, typically located at the top edge and bottom edge of the panel, but which also can be attached on an inside surface (that surface of the panel facing the interior of the building). Decorative hinges can be used, and when present, can be located on the outside surface (that surface of the panel facing the environment and away from the building). As shown in FIG. 6B, when the door is opening, the folding sections 350 allow panels to collapse onto each other, accordion-like, so that the face of one panel can come into contact with a face of another panel. In the embodiment depicted in FIG. 6B, the door opens from the center, the and panels move to a storage area on each side of the building opening. As the door panels 300 move from the center to each side along upper track 110 and lower track 210, they stack up next to each other into a compact stack, as shown in FIG. 6C, allowing easy storage into a recess or storage area without taking up the amount of area used by a conventional overhead door. FIG. 6C shows a top view of the door panels as they are opening, forming the compact stack.

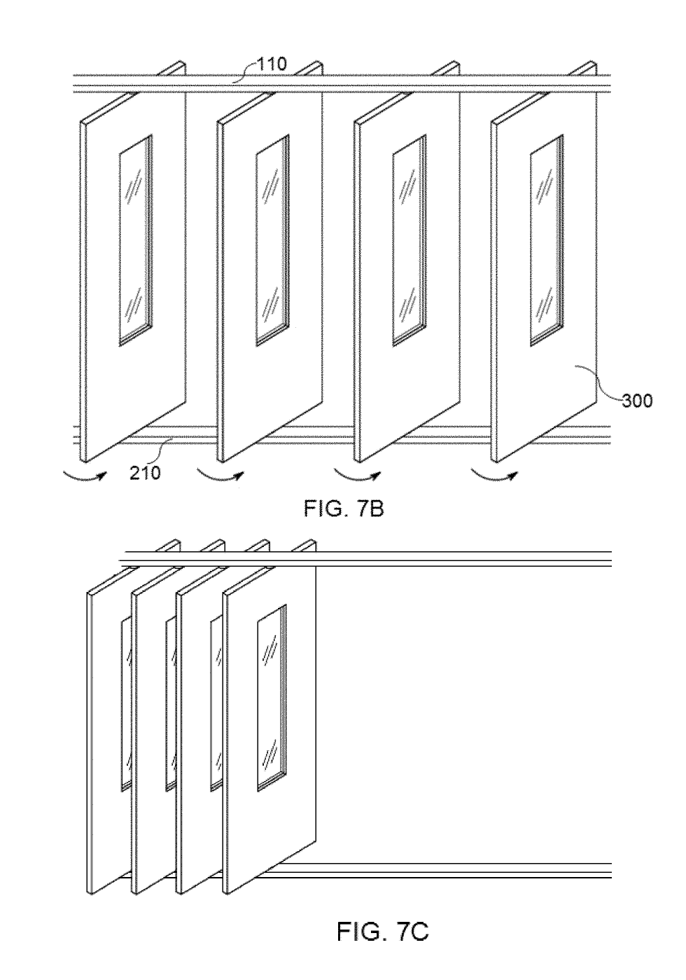

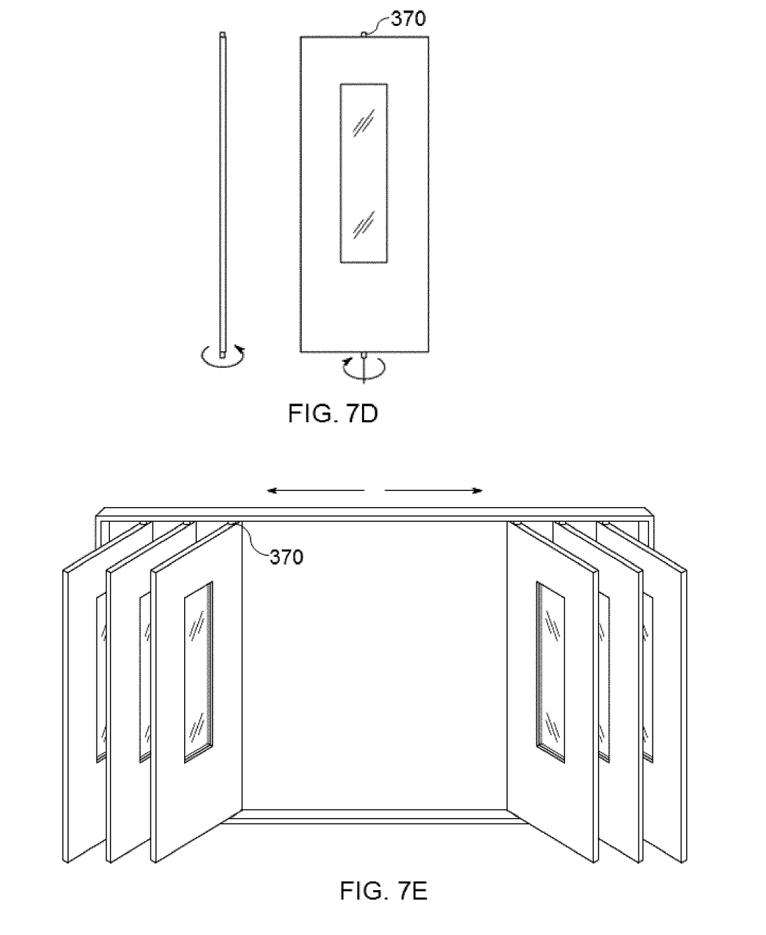

FIGS. 7A through 7E depict alternative embodiments of the door system provided herein. A closed door 950 or door system 1000 containing panels 300 which include windows 360 is depicted in FIG. 7A. When the door is to be opened, the panels 300 rotate about spindle 370 so that the panels are parallel to each other and perpendicular to the door opening, as depicted in FIG. 7B. The door operating mechanism (not shown) then moves the panels to one side of the garage opening along upper track 110 and lower track 210, stacking the panels one against another to form a compact stack of the panels, as shown in FIG. 7C. In an alternative embodiment (not depicted), the door can be opened from the middle and the panels can be stacked on both sides of the opening. In some embodiments, each panel can include its own movable trolley, which can include an electric motor and a gear system that allows the panel to be rotated about the axis of the spindle so that the panel can be placed into a position perpendicular to the door opening. The movable trolley also can include a gear system that can engage with gear along the upper track to allow the panel to be moved from one side of the opening to another. As shown in FIG. 7D, the spindle 370 can be located near the center of the door panel. Alternatively, as depicted in FIG. 7E, the spindle can be located at one end of the door panel. Each panel can be the same width or the panels can be of different widths to provide an aesthetic effect. The width of each panel can be from at or about 3 inches to at or about 24 inches (at or about 7.62 cm to at or about 60.96 cm), or 3 inches (7.62 cm) or greater, or 5 inches (12.7 cm) or greater, or 12 inches (30.48 cm) or greater, or 18 inches (45.72 cm) or greater.

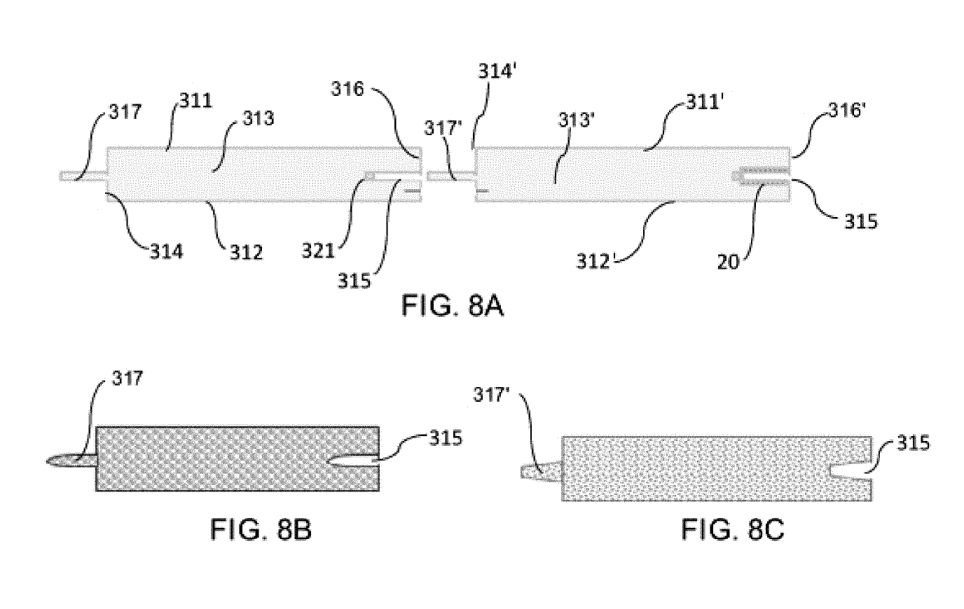

An exemplary door panel configuration is illustrated in FIG. 8A. As illustrated in FIG. 8A, a panel 300 has two face surfaces 311 and 312, a first horizontal short edge 314 containing a tongue portion 317, and an opposite second horizontal short edge 316 containing a recessed groove 315. The recessed groove 315 can include along its sides a compressible elastomeric material 320. The recessed groove 315 can include along the bottom of the groove a compressible elastomeric material 321. In some configurations, the recessed groove 315 can include along its sides a compressible elastomeric material 320 and along the bottom of the groove a compressible elastomeric material 321. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material 321 is configured so that it does not interfere with the nesting or interfitting relationship between the tongue portion 317 and the recessed groove 315. When present, the compressible elastomeric material should not interfere with the ability of the respective panels to pivot or rock relative to one another, as is typically necessary in connection with sectional garage doors. The elastomeric material can allow some movement f the interconnected panels without allowing the passage of air, dirt, duct, insects or pests through the interconnected panels.

The recessed groove 315 is designed and positioned along the first horizontal short edge 314 so that is it sufficiently deep relative to the tongue portion of a second panel to receive the tongue portion of the second panel and thereby join the first panel to the second panel. As shown in FIG. 8A, tongue portion 317′ of panel 300′ is configured and positioned to be received by recessed groove 315 of panel 300. The tongue portion and the recessed groove can act as a tenon and mortise, respectively. Although the figure depicts the tongue portion and the recessed groove to have a rectangular shape, any appropriate shape can be used. Exemplary shapes include a rectangular open mortise (having only three sides, as depicted in FIG. 8A), a curved bottom open mortise having a rounded bottom or U-shape (as illustrated in 8B), and a tapered mortise (having a tapered shape that is wider at the top (near edge 314) and narrower at the bottom as illustrated in FIG. 8C). When viewed from the front, panel 300 can be joined to panel 300′ by inserting tongue portion 316′ of panel 300′ into recessed groove 315 of panel 300. The intermeshing of the tongue and groove of the two panels bridges sheer forces and tensile forces between the core panels across the intermeshing joint as well as torsional stress. The intermeshing of the tongue and groove also stabilizes the panels relative to each other. The interlocked panels can exhibit substantial resistance to bending, for example, when subjected to high wind loading.

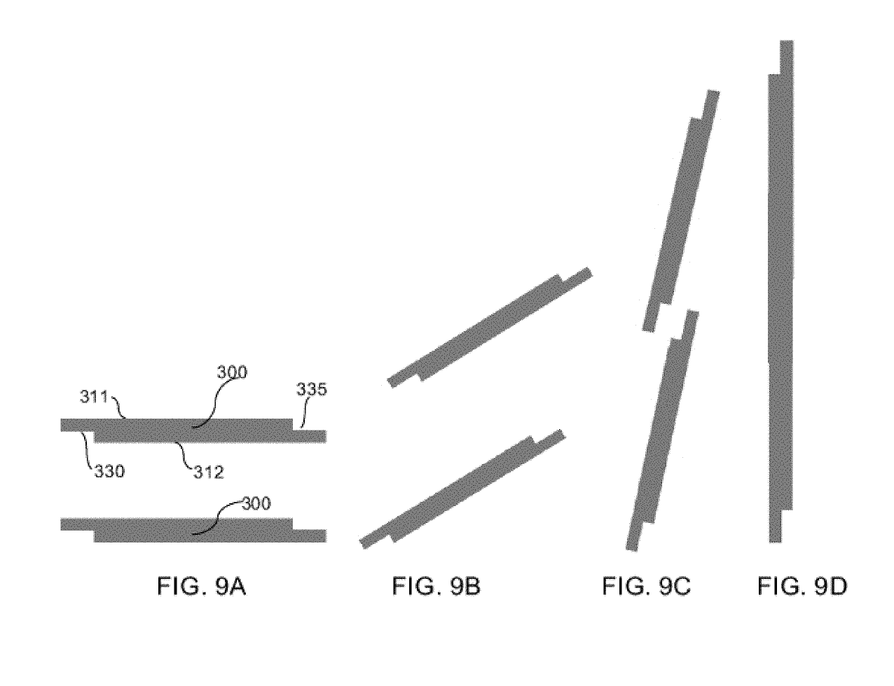

Instead of having a tenon and mortise configuration to join adjacent panels when in the closed position, adjacent panels can be configured to have interfitting half-lap joints, as depicted in FIGS. 9A through 9D, as viewed from above. In such configurations, the panel 300 can have two face surfaces 311 and 312, a first vertical long edge containing a positive of a half-lap joint 330 extending outwardly from the panel, and an opposite second vertical long edge containing a negative of a half-lap joint 335, which can receive the positive half-lap joint of another panel. When adjacent panels are brought together upon closing the door, such as illustrated by rotation of the panels in FIGS. 9B through 9D, the extended positive half-lap joint of one panel fits into the cutaway negative half-lap joint of the adjoining panel, thereby joining the first panel to the second panel.

The recessed groove or the negative half-lap joint of the panel member can include a compressible elastomeric material. The compressible elastomeric material can be or contain rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. When present, the compressible elastomeric material can be configured so that it does not interfere with the nesting or interfitting relationship between the tongue portion of one panel and the recessed groove or another panel, or the interfitting of the positive half-lap joint of one panel and the negative half-lap joint of another panel. When present, the compressible elastomeric material can be arranged to that it does not interfere with the ability of the respective panels to pivot or rock relative to one another. The elastomeric material can allow some movement of the interconnected panels without allowing the passage of air, dirt, dust, insects or pests through the interconnected panels.

The core of the panel can include an expanded polymeric material. For example, the core can include a polystyrene or polyurethane foam. The core can be rigid polystyrene or polyurethane foam. The core can contain aerogel (such as Pyrogel® aerogel insulation, which is a silica aerogel reinforced with glass fiber) or insulation microspheres (depicted in FIG. 9B) or vacuum insulated panels (VIPs, depicted in FIG. 9C) or combinations thereof. The core can be continuous or discontinuous. The core can have a honeycomb design (e.g., see U.S. Pat. No. 4,294,055 (Andresen, 1981) and U.S. Pat. No. 5,445,208 (Shaner et al., 1995)). The core can be affixed to and unitize the two face surfaces 311 and 312 to make the panel a single unit with a rigid lightweight structure. The core can be affixed, for example, by using an adhesive that can bond the expanded polymeric material to the interior facing face surfaces.

The panel can include one or more windows, as depicted in FIG. 7A. The windows can allow passage of light through the door when in the closed position, while maintaining an air-tight seal. The window can be of any transparent material. Examples include glass, acrylic and polycarbonate. The window can be constructed to have a transparent material, such as glass, present in a single layer, or a plurality of layers. The panel can include privacy glass, which can turn from transparent to opaque (e.g., see U.S. Pat. No. 4,749,261 (McLaughlin et al., 1988); U.S. Pat. No. 5,408,353 (Nichols et al., 1995); U.S. Pat. No. 8,441,707 (Lam et al., 2013); U.S. Pat. No. 8,665,512 (Friedman et al., 2014); and U.S. Pat. No. 8,736,938 (Schlam et al., 2014)). Variable transparency elements can be used in the privacy glass. The privacy glass can include an electro-chromic element. In the non-transparent mode, the privacy glass can provide privacy or to reduce glare and/or heating from sunlight or other light source. The substantially transparent condition can be selected for vision through the window and to allow thermal energy to pass through to heat a space. Liquid crystal electro-active elements including polymer layers carrying the electrodes and encapsulating the liquid crystal material are commercially available and can be used in the privacy glass. The privacy glass can be used to increase security so that observers cannot see through the glass when unwanted. Functionalization of the privacy glass can be controlled through a control panel attached to a computer control module.

Each panel 300 can have a thickness of from about 0.5 to about 3 inches. In some applications, a panel thickness of from about 1 to about 2 inches is preferred. The height of each panel can be selected for the size of the doorway opening to be sealed. The height of the doorway opening of typical garages in the U.S. typically is seven or eight feet in height.

The width of each panel can be selected for aesthetics. The narrower the panel, the more panels will be required to form a door that can close the building opening, such as the entryway of a residential garage. For example, the doorway opening of a typical single-car garage in the U.S. is about eight feet wide, and the doorway opening of a typical two-car garage in the U.S. is about sixteen feet wide. The assembled door typically is configured to include an extra 0.5 to 5 inches on each end to make sure that a complete seal is formed between the closed door and the doorway opening of the structure, such as a garage doorway. Accordingly, for two-car garage, and allowing 2 inches on each side of the door opening, fourteen 14-inch panels would be required to form a door. For two-car garage, and allowing 3 inches on each side of the door opening, nine 22-inch panels would be required to form a door.

The doorway opening of the building to which the door system provided herein is to be attached includes a compressible elastomeric material along the length of the horizontal header and each of the vertical beams located at either end of the doorway opening and defining the doorway opening of the building. The compressible elastomeric material can be of any elastomeric material. The compressible elastomeric material can be or contain rubber, polyolefin foam, vinyl, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. The elastomeric material is of a dimension sufficient to engage with the door when the frame is moved toward the doorway opening. For example, the compressible elastomeric material can have a height of from about 0.5 to about 2.5 inches. The compressible elastomeric material can have a height of from about 0.5 to about 2.5 inches. When the door is in position and ready to be closed, threaded member 430 is rotated by frame motor 450 to reposition the door system frame 110 toward the doorway opening. As the door system frame approaches the doorway opening, the panels of the door come into contact with the compressible elastomeric material outlining the doorway opening, deforming the compressible elastomeric material so that an airtight seal is formed between the panels of the door and the compressible elastomeric material outlining the doorway opening.

The bottom of each panel 300 can include a panel sealing element 390. The sealing element 390 can be of any elastomeric material. The panel sealing element 390 can be or contain rubber, polyolefin foam, vinyl, synthetic poly-isoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, and combinations thereof. The panel sealing element 390 conforms to the lower track 210 of the door system, and can accommodate horizontal movement as the door is positioned toward or away from the doorway opening. When in the closed position, the panel sealing element 390 forms an airtight seal between the lower portion of each door panel and the lower track 210 of the door system.

A control circuit for opening and closing the door can be a manually operated switch or a radio receiver-type switch and related circuitry, as are well known to those skilled in the art. When the door is in the closed position and the control circuit is activated, a threaded member of the movable connector 400 is rotated by a motor in one direction to reposition the upper track 110 away the doorway opening. When the upper track 110 has been repositioned away from the doorway opening, a motor of the door operating mechanism can be energized to drive a belt that moves the door panels toward one side or to each side of the garage door.

The control circuit also can include obstruction sensing circuitry to stop the closing of the door if an obstruction is detected that would prohibit closing of the door. Such circuits are conventional and their detailed description is not provided.

In case of a power failure, the system can include a back-up power supply. The back-up power supply can include a battery to energize the frame motors to move the upper track 110 away from the doorway opening and to energize a motor to move the door panels 300 to place the door 950 in the open position. The door system also can be operated manually.

The door system provided herein can produce less noise when moving the door into an open or closed position than produced by traditional garage doors. Quiet motors, such as stepper motors and conventional DC motors driven by a power control signal can be selected that result in the product of little noise, resulting in quiet operation of the door system. The actuator of the door system that places the door panels in a stacked position for storage can include rollers and noise dampening material to further produce a quiet operating door system. The storage of the door as collapsed panels in a vertical orientation allows for better utilization of garage storage, freeing up a significant amount of square footage in the ceiling area normally occupied by the door in traditional garage door systems. The airtight seal produced by the door system prevents entry of wind, rain, insects, pests and vermin into the garage. The door system thus promotes energy efficiency and cleanliness of the garage.

Many different types of motive power are capable of use for opening and closing the door of the systems provided herein, and the provided systems are not limited to a particular device or manner so capable. A mechanical, electromechanical, electrical, hydraulic, or pneumatic system can be provided to supply motive power to drive the opening and closing of the door. When an electro-mechanical system is used, it not limited in the manner in which the electro-mechanical system receives electrical power. For example, the electro-mechanical system can receive electrical power from a remotely located solar panel, or a battery located locally or remotely, or electrical power from line voltage via the structure in which the door system is installed.

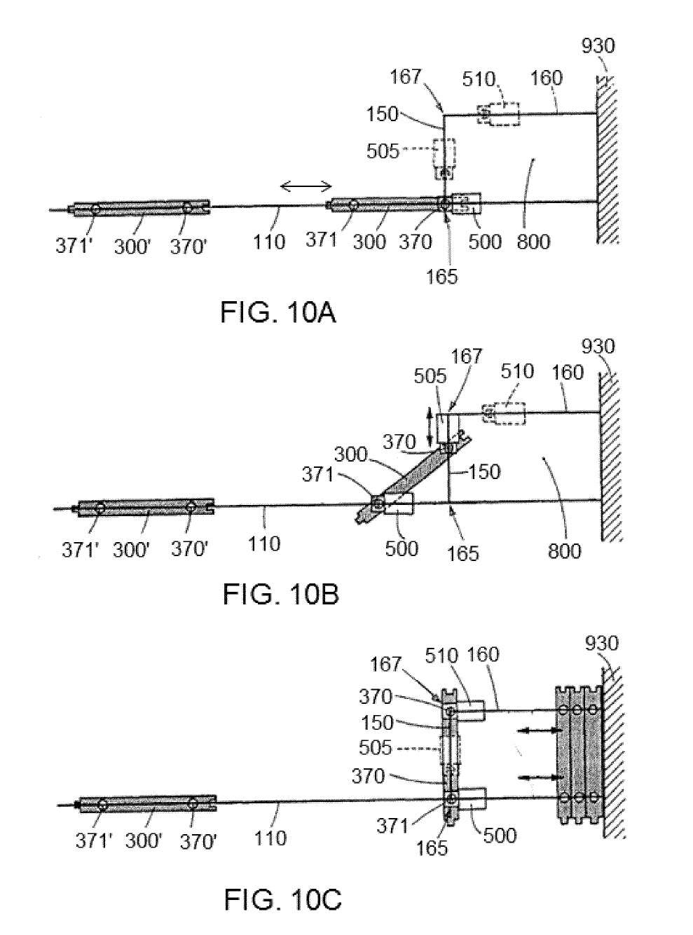

An exemplary operating mechanism is illustrated in FIGS. 10A through 10C. Movable trolleys 500, 505 and 510 are used to move the panels toward the side of the building, rotate the panel to be in a perpendicular direction from where it was initially, and then to stack the panels against each other to form a compact stack. Any movable trolleys known in the art can be used (see, e.g., U.S. Pat. No. 5,193,319 (Claassen et al., 1993); U.S. Pat. No. 5,406,761 (Hobbiebrunken et al., 1995); U.S. Pat. No. 5,930,953 (Estfeller, 1999); and U.S. Pat. No. 7,059,084 (Hoskeer, 2006)). As illustrated in FIGS. 10A through 10C, the movable trolleys can move along guide and slide rails about the upper track 110. The upper track 110 forms the main guide rail, which sets the course of the door panels as they move to open and close the building opening. The upper track 110 is attached to a ceiling upper rail 100, which is attached to the ceiling.

In order to allow the door panels to be repositioned into a perpendicular direction for stacking, a first guide rail 150 is provided, and positioned at a right angle to the upper track 110 and parallel to the stacking region 800. The first guide rail 150 has a length roughly that of the axial width of the support spindles 370 of each panel 300. The first guide rail 150 continues to a second guide rail 160, which runs parallel to the upper track 110.

The first movable trolley 500 moves the direction indicated by the arrow in FIG. 10A in order to couple at the support spindle 370 of the panel 300. The first movable trolley 500 faces in the direction of the building side wall 930 toward the stacking region 800. The first movable trolley 500 moves the panel 300 to the first branch point 165, which marks the beginning of the first guide rail 150. The first guide rail is positioned at an angle of 90° relative to the upper track 110 (as can be seen in FIG. 10A). The first movable trolley 500 decouples at the first branch point 165 and moves somewhat further along the upper track 110 in order to allow the coupling at the spindle support 370 by the second movable trolley 505 of the first guide guide rail 150. The second movable trolley 505 couples with the support spindle 370 of panel 300, and then the second movable trolley 505 moves in the direction indicated in FIG. 10B. This movement results in the panel being repositioned along the first guide rail 150 at an angle with respect to its starting position in the upper track 110 (see FIG. 10B) and finally perpendicular to its original position (see FIG. 10C). Once the second movable trolley 505 reaches the second branch point 167, the second movable trolley 505 then decouples from spindle 370 and assumes a position beneath the upper track 110. First movable trolley 500 then engages and couples with support spindle 371′ while movable trolley 510 engages and couples with the support spindle 371. After the coupling is complete, the two movable trolleys 500 and 510 synchronously move the panel in the direction of the stacking region 800 (see FIG. 10C). This panel 300 is decoupled by the movable trolleys 500 and 510 in the stacking region 800. The process is repeated until all panels 300 have been moved and stacked into the stacking region 800. The sequence of the motions is reversed in order to close the door system.

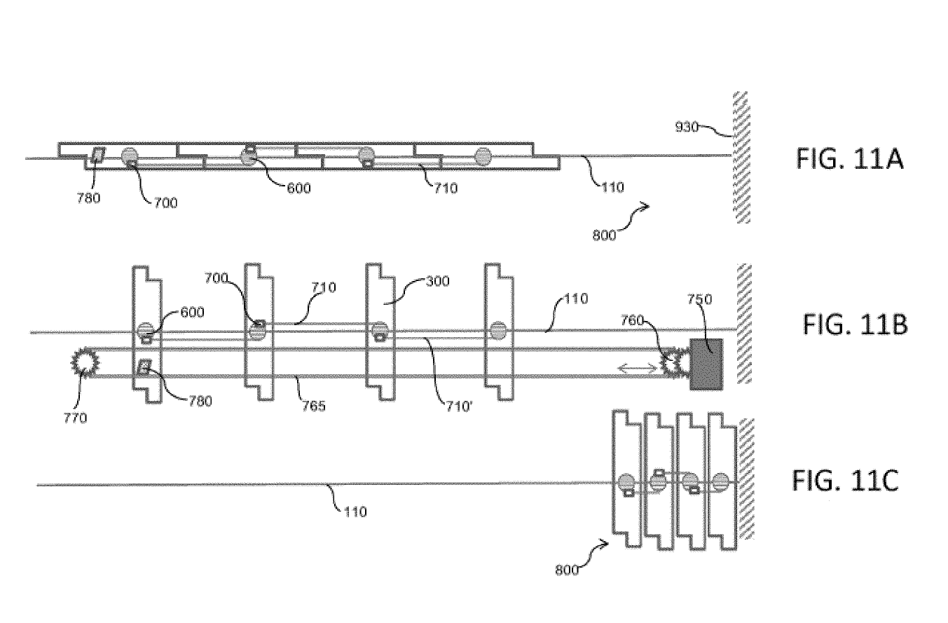

Another exemplary operating mechanism is illustrated in FIGS. 11A through 11C. The door panels 300 form the door 950 in the closed position, illustrated in FIG. 11A. Each panel 300 is connected to the upper track 110 via a motorized support 600. The motorized support includes a motor and mechanism to pivot the panels 300 from a position parallel to the building opening to a position perpendicular to the door opening, as shown in FIG. 11B. The motorized support can be configured to lock the panels in either a parallel configuration or a perpendicular configuration with respect to the building opening. Each panel 300 also includes a retractable cable device 700 connecting one panel to its adjacent panel via a retractable cable 710 (e.g., as shown in FIG. 11B, a first panel 300 is connected to its adjacent panel by retractable able 710, and the adjacent panel is connected to its adjacent panel via retractable cable 710′, and that panel is connected to its adjacent panel via retractable cable 710′). The retractable cable device 700 includes a mechanism by which the retractable cable is maintained under tension, and any slack in the retractable cable 710 is taken up by the retractable cable device 700. The mechanism can include a spring.

A motorized drive system 750 (drawings of which are omitted from FIGS. 11A and 11C to reduce complexity of the figures, but an exemplary embodiment of the motorized drive system is illustrated in FIG. 11B) is used to move the panels, stacking them together in a stacking region 800 near the building side wall 930, opening the door. Any motorized drive system can be used. In the exemplary system illustrated in FIG. 11B, the motorized drive system 750 includes a motor 755 attached to a first gear system 760 positioned in the vicinity of the motor 755, and a second gear system 770 positioned in the vicinity of where the door is to be opened. The first gear system 760 is attached to the second gear system 770 via a drive belt 765, such as a toothed belt. Rotation of the first gear system 760 by motor 755 in one direction causes the drive belt 765 to move toward the motor 755, while rotation of the first gear system 760 by motor 755 in the opposite direction causes the drive belt 765 to move away from the motor 755. The second gear system 770 allows the drive belt 765 to operate as a loop so that no slack is produced when the drive direction is changed.

The panel 300 at the position at which the door 950 of door system 1000 is to be opened includes a connector 780 that engages with the drive belt 765. When the door is to be opened, the motorized support 600 on each panel 300 is energized to rotate the panels 300 from a position parallel to the building opening to a position perpendicular to the building opening. The motorized support 600 then looks each panel into the perpendicular position. Motor 755 then is energized to rotate the drive belt 765 toward the motor 755 to open the door 950 of door system 1000. The connector 780 attached to the drive belt 765 exerts a force on the panel 300 to which it is attached, pulling the attached panel 300 in the direction that the drive belt 765 is moving. As the panel 300 attached to the drive belt 765 moves toward its adjacent panel, the retractable cable 710 is retracted into the retractable cable device 700, and the first panel 300 abuts its adjacent panel. The force exerted on the panel 300 attached to the drive belt 765 causes the abutting panel to move toward the motor 755 and toward the stacking region 800. This continues until all of the panels are abutting and stacked against each other in the stacking region 800. A sensor in the stacking region indicates that the panels are in storage and the power to the motor 755 is discontinued. The connector 780 can manually be disengaged from the drive belt 765 to allow manual operation of the door. For center-opening door systems, a motorized drive system 750 can be located on each side of the building opening, and a stacking region 800 for storage of the stacked panels would be located on both sides of the building opening.

Closing the door can be accomplished by reversing these steps. The motor 755 can be energized to cause rotation of the first gear system 760 in the opposite direction, causing the drive belt 765 to move away from motor 755. As the panel 300 attached to the drive belt 765 moves toward the center of the garage, the retractable cable 710 spools out of the retractable cable device 700 until it reaches its maximum length. The retractable cable 710 then exerts a force on the adjacent panel to which it is attached, pulling the adjacent panel along with the first panel 300 that is attached to the drive belt 765. This continues until all of the panels have been removed from the stacking region 800 and each of the retractable cables 710 have been fully extended, resulting in the panels being in their proper location for closing the door.

A sensor is triggered when all panels are in their proper position, and power to motor 755 is discontinued. A signal then is sent to each of the motorized supports 600 attached to each panel, rotating each panel 90 degrees so that they go from an orientation perpendicular to the building opening to a position parallel to the building opening. Rotation of the panels result in the extended positive half-lap joint of one panel fitting into the cutaway negative half-lap joint of the adjoining panel, thereby joining the first panel to the second panel and forming an airtight seal, closing the building opening. Because a toothed belt is used, noise from the opening and closing of the door can be minimized. A cable or a chain also can be used instead of a toothed belt. A low-noise motor can be used to mitigate a major source of the noise typically generated during opening and closing of conventional garage doors. Acoustic dampers or acoustic dissipaters can be included, such as by providing an acoustically insulated housing for the motor(s). Acoustic dampers or acoustic dissipaters, alone or in combination with insulating materials, also can be used in a housing or baffle of the drive system.

Each motorized support 600 on each panel 300 can be energized independently, allowing opening of a single panel, which can provide a sufficient amount of opening for an individual or pet to pass through and exit the garage without the need to open the full door.

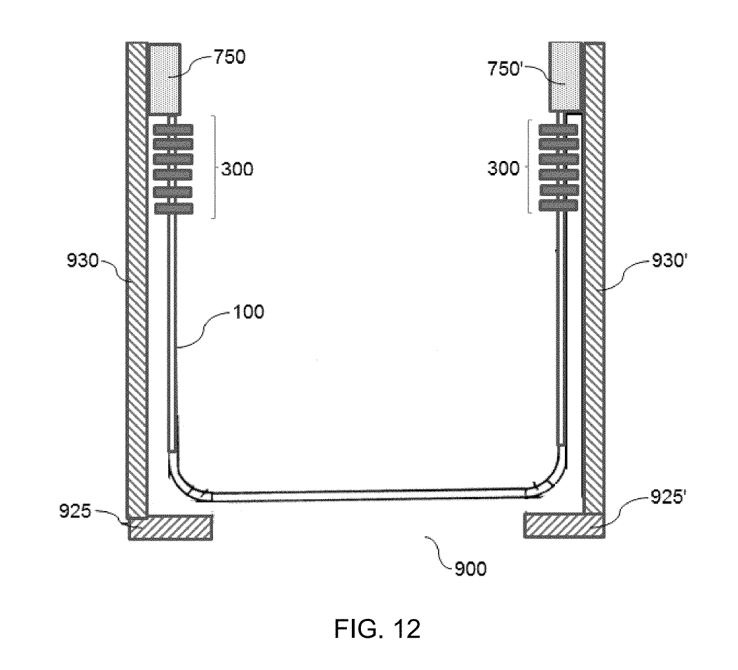

In configurations requiring maximum door opening clearance, such as in an airplane hangar, the frame of the door system can be movably coupled to a fixed ceiling rail having a U-shape. The panels move from the opening in the upper track connected to the ceiling rail and are moved toward the back of the building along the side walls, thereby eliminating any possible interference the panels of the open door could otherwise cause if stacked on one side or both sides of the door opening. An exemplary configuration is shown in FIG. 12. FIG. 12 shows a cutaway top down viewing looking down from above the building. As can be seen in FIG. 12, ceiling rail 100 has a U-shape and is fixed to the ceiling. When the door is to be opened, the movable connector (not shown) moves the upper track (not shown) along the ceiling rail 100 away from the building opening sealing element (not shown) and upward toward the interior ceiling of the building. This results in the panels 300 disengaging with the sealing element and moving with upper track towards the interior of the building away from opening 900 and the building front walls 920 and 920′. Motorized drive systems 750 and 750′ operate a cable or belt to move the panels 300 along the upper track following ceiling rail 100, positioning the panels 300 along building side walls 930 and 930′ away from the door opening, thereby maximizing the clearance of the door opening.

Methods

Also provided are methods for sealing an opening of a garage or other building structure for keeping out the elements, as well as dirt, dust, insects and pests. The methods include providing a sectional door system providing herein where the door contains a plurality of self-interlocking panels, and the door opens in a horizontal instead of a vertical direction. The panels can be configured to include a tongue portion and recessed groove, where the intermeshing of the tongue and groove of two adjacent panels prevent movement of air, dirt, dust, insects or pest through the door when in the closed position. The panels can be configured to include on one edge a positive half-lap joint extending outwardly from the panel, and an opposite edge containing a negative of a half-lap joint, which can receive the positive half-lap joint of another panel. When adjacent panels are brought together upon closing the door, the extended positive half-lap joint of one panel fits into the cutaway negative half-lap joint of the adjoining panel, thereby joining the first panel to the second panel, which prevents movement of air, dirt, dust, insects or pest through the door when in the closed position.

The methods include providing a door system frame that is movably attached to the structure, and positioning the door against a sealing member fixed to the structure to form a seal. The door system frame is moveably connected to a doorway opening of a structure, such as an opening in a garage, using an electro-mechanical connector, an electric-hydraulic connector, a hydraulic-connector, a pneumatic connector, an electro-pneumatic connector, a solenoid valve connector, a mechanical spring connector, or a combination thereof. The movable connector can include an electric actuator, a mechanical actuator, a hydraulic actuator, a pneumatic actuator, an electro-mechanical actuator, an electric-hydraulic actuator, an electro-pneumatic actuator, a piston rod cylinder, a rodless cylinder, an electric cylinder, an electric linear actuator, a pneumatic linear actuator, a hydraulic linear actuator, and combinations thereof.

In the methods provided herein, the panels of the door system provided herein are positioned to their closed position, in which the tongue portion of one panel is received into the recessed groove of an adjacent panel, joining the panels and inhibiting the passage of air therebetween, or the extended positive half-lap joint of one panel fits is received into the cutaway negative half-lap joint of the adjoining panel, thereby joining the first panel to the second panel and inhibiting the passage of air therebetween. Once all of the panels of the door have intermeshed, the movable door frame is moved toward the sealing member around the doorway opening by activation of the movable connector. The movable connector advances the frame until the panels are in contact with and form a seal with the sealing member about the building opening.

Also provided are methods for reversibly converting a garage space into a living space. The methods include sealing any vents or drains in the garage and installing a door system provided herein, the system including a sealing member fixed about the opening of the garage, a panel door and a frame that is movably attached to the opening of the garage, and positioning the door against the sealing member fixed about the garage door opening to form a seal. The door system frame can be moveably connected to the opening in the garage using an electro-mechanical connector, an electric-hydraulic connector, a hydraulic connector, a pneumatic connector, an electro-pneumatic connector, a solenoid valve connector, a mechanical spring connector, or a combination thereof. In the methods provided herein, the panels of the door system provided herein are positioned to their closed position, in which the tongue portion of one panel is received into the recessed groove of an adjacent panel, joining the panels and inhibiting the passage of air therebetween, or the extended positive half-lap joint of one panel fits is received into the cutaway negative half-lap joint of the adjoining panel, thereby joining the first panel to the second panel and inhibiting the passage of air therebetween. Once all of the panels of the door have intermeshed, the movable door frame is moved toward the sealing member around the doorway opening by activation of the movable connector. The movable connector advances the frame until the panels are in contact with and form a seal with the sealing member about the garage opening. The system can include an air handling system that can circulate fresh filtered air into the garage. The system can include an air conditioning system to regulate the humidity or temperature or both within the reclaimed garage space. The methods also can include installing duct work that allows the reclaimed space to be tied into the building's existing heating or cooling systems.

A pressure regulator can be included to allow ventilation and maintain ambient pressure within the converted living space. The pressure regulator allows a properly balanced inflow and outflow of air to maintain appropriate ambient pressure within the living space with changes in barometric and/or atmospheric pressure, such as caused by changes in weather or wind. The pressure regulator can include inlet and outlet flow valves that will automatically operate to prevent overly low or high pressures within the living space relative to the outside pressure by admitting outside air should the external atmosphere tend to increase over the internal pressure, or by venting inside air externally should the external pressure decrease relative to the internal pressure within the living space. The flow valves can include solenoids that can be controlled manually or automatically by or in accordance with pressure-sensitive devices.

While various embodiments of the subject matter provided herein have been described, it should be understood that they have been presented by way of example only, and not limitation. Since modifications will be apparent to those of skill in this art, it is intended that this invention be limited only by the scope of the appended claims.

### LIST OF FIGURE ELEMENTS

100 Ceiling rail
110 Upper track
115 Groove
150 First guide rail
160 Second guide rail
165 First branch point
167 Second branch point
210 Lower track
220 Gasket
220′ Gasket
265 Lower close-up
290 Floor sealing element
300 Panel
310 Hinge
311 Interior face surface
312 Exterior face surface
313 Core
314 First horizontal short edge
315 Recessed groove
316 Second horizontal short edge
317 Tongue portion
320 Side compressible elastomeric material
321 Bottom compressible elastomeric material
330 Positive of half-lap joint
335 Negative of half-lap joint
350 Folding section
360 Window
365 Upper close-up
370 Spindle
371 Spindle
371′ Spindle
375 Spring assembly
376 Spring
378 Spindle support
379 Fastener
380 Wheel
390 Panel sealing element
400 Upper movable connector
430 Threaded member
440 Lower movable connector
450 Frame motor
500 First movable trolley
505 Second movable trolley
510 Third movable trolley
600 Motorized support
700 Retractable cable device
710 Retractable cable
710′ Retractable cable
750 Motorized drive system
755 Motor
760 First gear system
765 Drive belt
770 Second gear system
780 Connector
800 Stacking region
900 Building opening
910 Opening sealing element
920 Header above the building opening
925 Building front wall
925′ Building front wall
930 Building side wall
940 Building interior ceiling
950 Door
1000 Door system

1. A sectional door system for closing an opening in a building, the system comprising:
a plurality of panels, each panel comprising:
a first face surface;
a second face surface;
a core;
a first edge containing a recessed groove and an opposite second edge containing a tongue portion, or a first edge containing a positive of a half-lap joint, and an opposite second edge containing a negative of a half-lap joint;
a frame within which the panels can move;
an operating mechanism for opening and closing the door horizontally by moving the panels within the frame;
a sealing member attached about the opening in the building; and
a movable connector for movably connecting the frame to the building for reversibly engaging the panels with the sealing member to form an airtight seal.

2. The system of claim 1, wherein the tongue portion of one panel is insertable in the recessed area of an adjacent panel to join the panels and inhibit the passage of air therebetween.

3. The system of claim 1, wherein the positive half-lap joint of one panel fits into the cutaway negative half-lap joint of the adjoining panel, thereby joining the first panel to the second panel and inhibiting the passage of air therebetween.

4. The system of claim 1, wherein:
a) the core comprises a unitary expanded polymeric material comprising a polystyrene foam or polyurethane foam or a combination thereof; or
b) the core has a honeycomb design; or
c) the core comprises an aerogel; or
d) the core comprises a plurality of insulation microspheres; or
e) the core comprises one or more vacuum insulated panels; or
f) any combination of a), b). c), d) and e).

5. The system of claim 1, wherein the core comprises a shrapnel slowing material selected from among an aramid material, a para-aramid material, boron carbide tiles, a carbon fiber composite material, a ballistic nylon, a ballistic fiberglass, a ballistic polyethylene composite comprising ultra-high molecular weight polyethylene (UHMWPE) fiber, a composite comprising carbon fiber and UHMWPE fiber, ceramic tiles, and a combination thereof.

6. The system of claim 1, wherein:
a) the panel comprises an insulating material to reduce the transmission of thermal energy or sound energy or both; or
b) the panel comprises a layered composite construction, with different materials layered during fabrication of the panel; or
c) the panel has no visible seams; or
d) the panel has thermal resistance or R value ranging from 30 to 60; or
e) and combination of a), b), c) and d).

7. The system of claim 1, wherein:
a) the first face surface or second face surface or both comprises a thermoplastic resin, or resin reinforced fiberglass, or carbon-fiber-reinforced plastic, or a composite or a combination thereof; or
b) the first face surface or second face surface comprises epoxide resin based carbon fiber-reinforced plastic; or
c) the first face surface or second face surface comprises acrylonitrile butadiene styrene copolymer (ABS), polycarbonate acrylonitrile butadiene styrene copolymer (PC/ABS), polyether-ether-ketone (PEEK), polyetherketone ketome (PEKK), polyethereimide (PEI), polypropylene (PP), polyphenylene sulfide (PPS), polyvinyl chloride (PVC), or a thermoplastic olefin (TPO) or any combination thereof; or
d) any combination of a), b) and c).

8. The system of claim 1, wherein the panels further comprise a surface coating, wherein:
a) the surface coating comprises a thermoplastic elastomer, a thermoplastic vulcanizate or an aromatic polyurea/polyurethane hybrid elastomer system or combinations thereof; or
b) the surface coating comprises Line-X® brand aromatic polyurea/polyurethane hybrid protective coating; or
c) wherein the surface coating is on an internal surface of the panel, or the first face surface, or the second face surface or any combination thereof; or
d) any combination of a), b) and c).

9. The system of claim 1, wherein:
the first face surface of the panel faces external to the opening of the building or structure; and
the second face surface of the panel faces internal to the opening of the building or structure.

10. The system of any claim 1, wherein the core is between the first face surface and second face surface of the panels and adhesively bonded thereto to form a unitary unit.

11. The system of claim 1, wherein at least one panel comprises a window, wherein:
a) the window comprises a polymer film comprising a polyvinylbutyral (PVB) or ethylene vinyl acetate (EVA) or a combination thereof; or
b) the window comprises a privacy glass; or
c) the window comprises an electro-chromic element; or
d) the window comprises at least two layers of transparent material separated by a space, wherein the space between the two layers of transparent material is evacuated or filled with an inert gas; or
e) the window comprises a transparent metal oxide layers that can reflect at least one wavelength of electromagnetic radiation; or
f) any combination of a), b), c), d), and e).

12. The system of claim 1, wherein:
a) at least one panel comprises a decorative design or embossment, wherein the decorative design or embossment is on a face surface positioned toward the exterior environment or toward the interior of the building or both; or
b) the panel has one decorative design or embossment on one face surface and a different decorative design or embossment on the other face surface; or
c) both a) and b).

13. The system of claim 1, further comprising a ceiling rail having a U-shape.

14. The system of claim 1, further comprising an interchangeable cover that can be fastened to the first face surface or the second face surface or both to change the aesthetic appearance of the door.

15. The system of claim 1, wherein the panels have a thickness of from about 0.5 to about 3 inches.

16. The system of claim 1, further comprising a coupling joining adjacent panels.

17. The system of claim 16, wherein the coupling comprises a hinge.

18. The system of claim 1, wherein a surface of the recessed groove or a surface of the negative of the half-lap joint further comprises a compressible elastomeric material comprising rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof.

19. The system of claim 1, wherein the recessed groove has a shape selected from among rectangular, tapered and U-shaped.

20. The system of claim 1, wherein the frame comprises an upper track and a lower track.

21. The system of claim 20, wherein the upper track and the lower track comprise a groove that can engage with a wheel that allows the panels to move along the track.

22. The system of claim 42, wherein:
a) the wheel comprises a material selected from among metal, nylon, plastic, and wood; or
b) the wheel comprises a coating selected from among an elastomeric coating, a polymer coating, a Teflon coating, a plastic coating and a nylon coating; or
c) both a) and b).

23. The system of claim 20, wherein the lower track of the frame is movably attached to a rail affixed to a floor of a building.

24. The system of claim 23, wherein a sealing element is between the movable rail and the floor and forms an airtight seal therebetween.

25. The system of claim 20, wherein the upper track or the lower track or both include a surface coating.

26. The system of claim 25, wherein the surface coating comprises an elastomeric coating comprising polytetrafluoroethylene, polyamide, perfluoroelastomer, rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof.

27. The system of claim 1, further comprising:
a) a light activated when the door operating mechanism is energized; or
b) a receiver responsive to a transmitter; or
c) an obstruction sensor or a reverse trip switch or both; or
d) an infrared optical sensor; or
e) a manual switch to deactivate the door system; or
f) a carbon monoxide sensor and an alarm; or
g) a smoke detector and an alarm; or
h) an infrared tripping sensor; or
i) a variable resistance sensor; or
j) a particle detector or air quality sensor; or
k) an alternate power source that can be used in case of interruption of utility services; or
l) any combination of a) through k).

28. The system of claim 1, further comprising a computer module comprising a computer in communication with and/or in control of at least one part of the door system.

29. The system of claim 28, wherein:
a) the computer communicates with a control system to automate or operate the opening and closing of the door; or
b) the computer communicates with a control system to operate a light, a mechanical component, an operating mechanism, a touch panel, or automatic closing and locking mechanisms or any combination thereof; or
c) both a) and b).

30. The system of claim 28, wherein the computer module comprises a non-transitory computer-readable storage medium having a computer-readable program embodied therein for directing operation of the door system and/or any component of the system.

31. The system of claim 1, wherein:
a) the system is configured to interact with a smart house product; or
b) the system is configured to interact with a smart phone; or
c) both a) and b).

32. The system of claim 1, wherein the sealing member comprises a compressible material that is reversibly deformable and conforms in shape to the surface of an object brought into contact with the sealing member.

33. The system of claim 32, wherein the compressible material comprises a sponge rubber or a foamed plastic or a plastic resin or a compressible elastomeric material comprising rubber, vinyl, polyolefin foam, synthetic polyisoprenes, polybutadienes, polychloroprenes, chlorosulfonated polyethylenes, elastomeric polyurethanes, fluorinated elastomers, isoprene-isobutylene copolymers, ethylene-propylene-diene copolymers, styrene-isoprene-styrene block copolymers, styrene-ethylene-butylene-styrene block copolymers, or a combination thereof.

34. The system of claim 1, wherein:
a) the sealing member comprises a resilient semi-circular strip of elastomeric compressible material; or
b) the sealing member comprises a hollow opening in the interior of the sealing member that extends the length of the material; or
c) the sealing member comprises an elastomeric reservoir containing a quantity of fluid secured to a header above the opening of the building or structure and spaced tubular elastomeric members secured at each side of the door opening to the building structure, where fluid forced into the tubular members extend them into sealing contact with the side edges of the panels of the door; or
d) any combination of a), b) and c).

35. The system of claim 1, wherein the movable connector comprises an electro-mechanical connector, an electric-hydraulic connector, a hydraulic connector, a pneumatic connector, an electro-pneumatic connector, a solenoid valve connector, a mechanical spring connector, or a combination thereof.

36. The system of claim 1, wherein the movable connector comprises a threaded member that can:
a) move the frame toward the building or structure to engage with the sealing member to form a seal; and
b) move the frame away from the building or structure to disengage with the sealing member.

37. The system of claim 36, wherein the movable connector further comprising a pair of metal plates that contain an internally threaded opening that accepts the threaded member, wherein one metal plate of the pair can be attached to an element of the structure, and the other metal plate of the pair can be attached to the frame, and rotation of the threaded member by a motor in one direction repositions the frame toward the opening of the building or structure, and rotation of the threaded member by the motor in the opposite direction repositions the frame away from the opening of the building or structure.

38. The system of claim 37, wherein the motor is a direct-current motor driven by a power control signal or a stepper motor.

39. The system of claim 38, further comprising a control circuit programmed to control rotation of the motor in the forward and reverse directions.

40. The system of claim 1, wherein the movable connector comprises:
a pair of arms, disposed symmetrically around a central axis; and
a piston to push the arms apart or to pull the arms together, thereby bringing the frame toward or away from the building or structure opening, wherein the piston is operated electrically, hydraulically or pneumatically.

41. The system of claim 1, wherein the movable connector comprises a gear attached to a drive shaft, a motor, and a cable or chain driven by the motor to rotate the gear and drive shaft to reposition the frame of the door closer to or away from the building or structure opening.

42. The system of claim 1, wherein the movable connector comprises an electric actuator, a mechanical actuator, a hydraulic actuator, a pneumatic actuator, an electro-mechanical actuator, an electric-hydraulic actuator, an electro-pneumatic actuator, a piston rod cylinder, a rodless cylinder, an electric cylinder, an electric linear actuator, a pneumatic linear actuator, a hydraulic linear actuator, and combinations thereof.

43. The system of claim 1, wherein the door operating mechanism comprises a mechanical opener, an electromechanical opener, an electrical opener, a hydraulic opener, a pneumatic opener or combinations thereof.

44. The system of claim 1, wherein the door operating mechanism comprises an electric motor, a chain drive mechanism, and a length of a bicycle-type chain geared to the chain drive mechanism driven by the electric motor.

45. The system of claim 1, wherein the door operating mechanism comprises movable trolleys that reposition the panels from an orientation parallel to the opening to an orientation perpendicular to the opening and move the panels to stack the panels abutting each other to form a compact storage of the panels.

46. The system of claim 1, wherein the door operating mechanism comprises an electric motor, a drive mechanism, and a length of toothed belt geared to the drive mechanism driven by the electric motor.

47. The system of claim 1, further comprising:
a) a mechanical locking system or electronic locking system or a combination thereof; or
b) a thermometer or humidity meter; or
c) a color-coordinated lighting system to convey information; or
d) a blower system; or
e) a ventilation system; or
f) an automatic timer; or
g) any combination of a), b), c), d), e) and f).

48. A door system including a plurality of panels, movable and positionable along guide rails to open and close an opening horizontally, wherein the panels are moved in a direction along the guide rails by a combination of movable trolleys, where the movable trolley runs inside of a guide profile and reposition the panels from an orientation parallel to the opening to an orientation perpendicular to the opening and stack the panels abutting each other to form a compact storage of the panels.

49. A method for sealing an opening of a garage or other structure, comprising:
providing a sectional door system of claim 1;
activating the operating mechanism to position the panels in their closed position, in which:
the tongue portion of one panel is received into the recessed groove of an adjacent panel, joining the panels and inhibiting the passage of air therebetween; or
the extended positive half-lap joint of one panel fits into the cutaway negative half-lap joint of the adjoining panel, thereby joining the first panel to the second panel and inhibiting the passage of air therebetween; and
activating the movable connector to advance the frame towards the opening until the panels are in contact with and form a seal with the sealing member.

50. A method for reversibly converting a garage space into a living space, comprising:
sealing any vents or drains in the garage;
installing a pressure regulator; and
installing the door system of claim 1.
